(19) United States
(12) Patent Application Publication
(10) Pub. No.: US 2004/0261547 A1
(43) Pub. Date: Dec. 30, 2004

(54) Method of deriving data

(76) Inventors: David Alexander Russell, Edinburgh (GB); Gordon Campbell Short, Edinburgh (GB)

Correspondence Address: MOSER, PATTERSON & SHERIDAN, L.L.P., 3040 POST OAK BOULEVARD, SUITE 1500, HOUSTON, TX, 77056-6582, US

(21) Appl. No.: 10/675,863

(22) Filed: Sep. 30, 2003

Related U.S. Application Data
(60) Provisional application No. 60/415,323, filed on Oct. 1, 2002.

(51) Int. Cl. G01M 19/00

(52) U.S. Cl. 73/865.8

(57) ABSTRACT

Method, apparatus and article of manufacture for detecting a physical condition in a pipeline. In one aspect, there is provided a method of detecting a physical condition in a pipeline by obtaining vibration data from the pipeline which is representative of the physical condition. In one embodiment, physical condition is any corrosion in the pipeline.

### CROSS-REFERENCE TO RELATED APPLICATIONS

This application claims priority to U.S. provisional patent application Ser. No. 60/415,323, filed Oct. 1, 2002, and is related to UK Patent Application No. 9620635.4, entitled “PIPELINE CONDITION MONITORING SYSTEM AND APPARATUS” filed Oct. 3, 1996, each of the aforementioned is herein incorporated by reference.

### BACKGROUND OF THE INVENTION

1. Field of the Invention

The present invention relates to a method of deriving data representative of the condition of a pipeline and more particularly for detecting corrosion in the pipeline by obtaining vibration data which is representative of any corrosion in the pipeline.

2. Description of the Related Art

The safe and continuous operation of hydrocarbon pipeline networks are essential to the operators and users of such networks and to national economies served by such networks. Accordingly, such pipelines are cleaned and inspected at regular intervals to ensure their operational integrity.

The conventional approach to inspection of pipelines is for the pipeline to be cleaned several times using a “dumb” pig. The “dumb” pig operates to scrape and remove debris such as wax, scale, sand and other foreign matter from the pipeline while maintaining fluid supply via the pipeline. Subsequently, detailed inspection is performed by an “intelligent pig”, which makes detailed measurements of the pipeline to determine the internal condition of the pipe. The “intelligent pig” is equipped with complex tools generally comprising arrays of probes and sensors and techniques such as magnetic flux leakage (MFL) or ultrasonic scanning (at various positions along the pipeline) to detect flaws or defects, which might prejudice the pipeline's integrity.

One shortcoming of conventional pigging techniques is that many cleaning pigs simply fail to effectively clean a pipeline at all points therealong. Therefore, when an intelligent pigging operation is undertaken the results obtained may be inaccurate, misleading or useless because the pipeline is not clean and the measurements have been distorted as a result. Such intelligent pigging operations are typically very costly, and thus it will be appreciated that is highly desirable that the information and data obtained be as accurate and reliable as possible in order to avoid unnecessarily wasted expense and lost production time, and the risk of pipeline integrity failure not being detected.

Therefore, there is a need for a cost efficient and effective method and apparatus for determining the condition of pipelines.

### SUMMARY OF THE INVENTION

The present invention generally provides for methods and apparatus for detecting a physical condition in a pipeline.

In one embodiment, there is provided a cost efficient method of detecting a physical condition in a pipeline by obtaining vibration data from the pipeline which is representative of the physical condition. In one embodiment, physical condition is any corrosion in the pipeline. Data can be obtained along the entire length of the pipeline.

In another embodiment, there is provided a method of deriving data representative of a condition of the pipeline comprising: passing a pipeline pig along a pipeline; sensing a vibration frequency of the pig as it moves along the pipeline to generate data representative of the frequency response of the pipeline pig; and analyzing the frequency data to give data representative of the condition of the pipeline.

In another embodiment, the method further includes the step of collecting data representative of the pig position along the pipeline.

In another embodiment, the method further includes the step of collecting data representative of the speed of travel of the pig along the pipeline.

In another embodiment, the method further includes the step of controlling the speed of the pig to within a suitable range to generate vibration frequency data characteristic of the internal condition of the pipeline.

In yet another embodiment, the pig guide diameter, seal diameter and thickness are selected to generate vibration frequency data characteristic of the internal condition of the pipeline.

In yet another embodiment, the speed at which the pig is passed along the pipeline and/or the pig guide diameter and/or seal diameter and/or the thickness are selected to give a desired frequency response.

In yet another embodiment, the frequency data and the data representative of the pig position along the pipeline and the speed of travel of the pig along the pipeline are correlated to obtain an indication of the condition of the pipeline.

In yet another embodiment, the data is processed to remove frequency responses resulting from the pig passing joins in the pipeline and/or rounding bends in the pipeline.

Yet another embodiment provides a method of deriving data representative of a condition of a pipeline comprising: passing a pipeline pig along a pipeline; generating data representative of an acoustical characteristic of the pipeline pig made as the pipeline pig moves through the pipeline pig; and analyzing the data to determine a condition of the pipeline.

Still another embodiment provides a method of deriving data representative of a condition of a pipeline comprising: passing a pipeline pig along a pipeline; sensing a frequency response generated by the pipeline pig as it moves along the pipeline; generating data representative of the frequency response; and analyzing the data to give data representative of the condition of the pipeline.

Still another embodiment provides a computer readable medium containing a program which, when executed, performs an operation, comprising: receiving a sensed frequency response generated as the pig moves along a pipeline by interaction between a physical structure of the pipeline pig and at least one of a structure of the pipeline and debris formed on the pipeline; and generating data representative of the frequency response.

Still another embodiment provides an onboard pipeline pig system, comprising: one or more vibration sensors configured to collect a sensed frequency response generated as a pig moves along a pipeline by interaction between a physical structure of the pipeline pig and at least one of a structure of the pipeline and debris formed on the pipeline; and a processor connected to receive information representative of the sensed frequency response.

Still another embodiment provides a pipeline pig, comprising: a casing; an onboard pipeline pig system disposed at least partially within the casing and comprising: one or more vibration sensors configured to collect a sensed frequency response generated as the pig moves along a pipeline by interaction between a physical structure of the pipeline pig and at least one of a structure of the pipeline and debris formed on the pipeline; and a processor connected to receive information representative of the sensed frequency response.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is one embodiment of a pig, shown in perspective.

FIG. 2 is another embodiment of a pig, shown in perspective.

FIG. 3 is another embodiment of a pig, shown in perspective.

FIG. 4 is a cross sectional view of a pig showing one embodiment of an onboard system.

FIG. 5 is a cross sectional view of a pig showing another embodiment of an onboard system.

FIG. 6 summarizes the metal loss achieved in each of four (corroded) test spools.

FIGS. 7-52 are graphs showing data for various configurations of a pig.

FIGS. 53-54 are plots of amplitude with respect to time and frequency, respectively.

FIGS. 55-56 are plots of amplitude with respect to time and frequency, respectively.

### DETAILED DESCRIPTION OF A PREFERRED EMBODIMENT

In general, there is provided an apparatus for, and method of, detecting a physical condition in a pipeline by obtaining vibration data from the pipeline, wherein the data is representative of the physical condition. In one embodiment, physical condition is any corrosion in the pipeline. In one aspect, data can be obtained along the entire length of the pipeline. It will be appreciated that the term “condition” with respect to a pipeline, may embrace a variety of different and independent pipeline factors such as debris deposits, joints, bends, etc., the combination of which will provide an overall pipeline condition profile.

Apparatus and Operation

The apparatus of the invention may generally include any variety of passive and active devices suitable for facilitating collection of pipe condition information. As used herein the expression “passive devices” indicates sensing devices which simply record physical effects associated with the passage of the pipeline pig such as changes in pressure, speed, acceleration, noise, vibration, temperature etc. as opposed to “active devices” which probe the pipeline e.g. with radiation, sound waves etc.

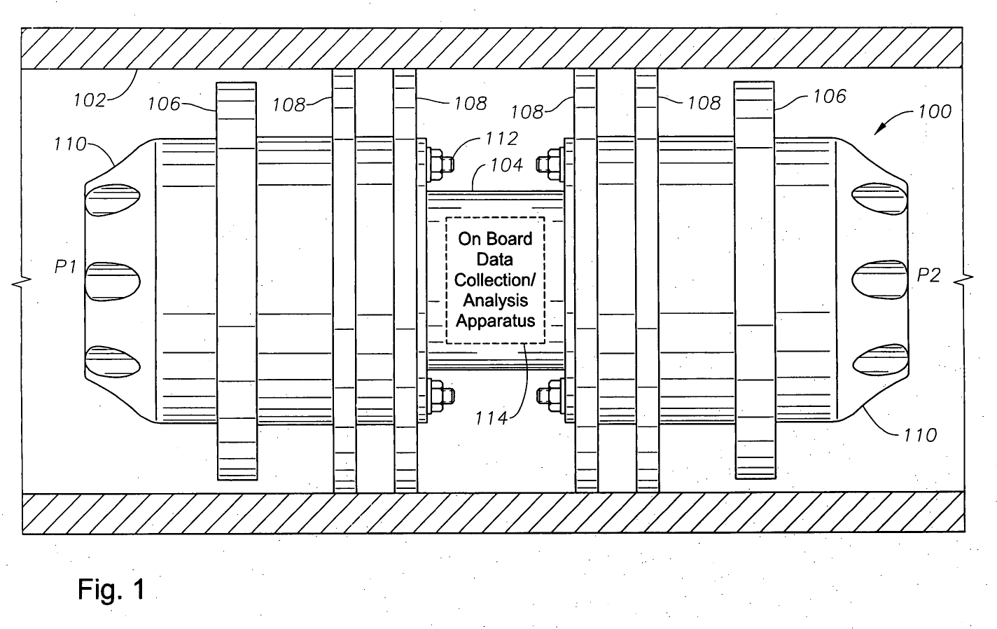

Referring to FIG. 1, a pig 100 according to one embodiment of the invention is shown. The pig 100 is shown disposed in a pipeline 102. Illustratively, the pig is bi-directional to allow movement in either direction through the pipeline. The pig 100 is motivated by the difference in pressure of the fluid (e.g., oil or gas) in the pipeline 102 across the pig 100 (indicated by ‘P1’and ‘P2’). In one embodiment, the pig 100 may incorporate aspects of pigs commonly used in pigging operations in the oil and gas industry. As such, the pig 100 includes a casing 104 mounted on and between two spaced apart guides 106. The guides 106 have a diameter slightly less than the internal diameter of the pipeline 102. The pig 100 further includes four spaced apart cleaning seals 108, disposed between the guides 106. The cleaning seals 108 have a diameter generally greater than the internal diameter of the pipeline and are made of resilient materials so that, in use inside the pipeline 102, the periphery of the seals 108 is deflected into a sealing engagement with the inside wall of the pipeline 102. End plates 110 are disposed on either end of the pig 100. The components of the collective assembly are fastened to one another by bolts 112.

The pig 100 is equipped with an on-board data collection system 114. The onboard data collection system 114 generally comprises any combination of sensors, detectors, memory devices, processors, power supplies, support circuits, etc, which allow collection of various data as the pig 100 moves along the pipeline 102. This data can then be analyzed off-line. Alternatively, the system 114 includes on-board data processing equipment for performing at least some processing of data obtained from the sensing devices on-board the pig 100. In this manner, the data can be analyzed on-line as the pig 100 passes along the pipeline 102.

Various forms of sensing devices/techniques may be utilized. In one embodiment, a single sensing device is used. In another embodiment, a plurality of different sensing devices are employed. Suitable sensing devices may be formed and arranged for detecting one or more parameters associated with interaction of the pig 100 with debris deposits and/or the passage of the pig 100 in the pipe, as it passes along the length of pipeline 102 and is perturbed by debris deposits or other pipeline conditions. Such parameters include: differential pressure across the pig between a leading end and a trailing end thereof; velocity of the pig as it passes along a length of pipeline; longitudinal, and optionally angular, acceleration and deceleration of the pig as it passes along a length of pipeline; vibrations; noise (including amplitude and/or frequency characteristics thereof) generated by interaction of the pig with the wall of the pipeline and/or deposits thereon or other pipeline conditions; temperature gradients and variations; and friction between the pig and the pipeline wall.

In one embodiment, the pig 100 can generate and record amplitude and/or frequency data representative of the vibrations generated by interaction of the pig with the wall of the pipeline and/or deposits thereon or other pipeline conditions. The analysis of the frequency data gives data representative of the condition of the pipeline in particular providing an indication of corrosion within the pipeline because certain frequency responses are only obtained when the pig passes corroded sections of the pipeline. In another embodiment, the pig 100 is configured to generate data which is analyzed for patterns, or signatures. Each of these analysis techniques are described in more detail below.

In one embodiment, the pig 100 is operated as cleaning pig. That is, the guides 106 act as scrapers to clear away debris on the inside wall of the pipeline as the pig 100 passes through the pipeline 102 while collecting data. The data may then be processed to determine a physical condition of the pipeline 102. In one aspect, the data is used to determine whether additional intelligent pigging is required. Alternatively, or additionally, the pig 100 may be operated to traverse the pipeline 102 subsequent to a cleaning operation and/or subsequent to intelligent pigging.

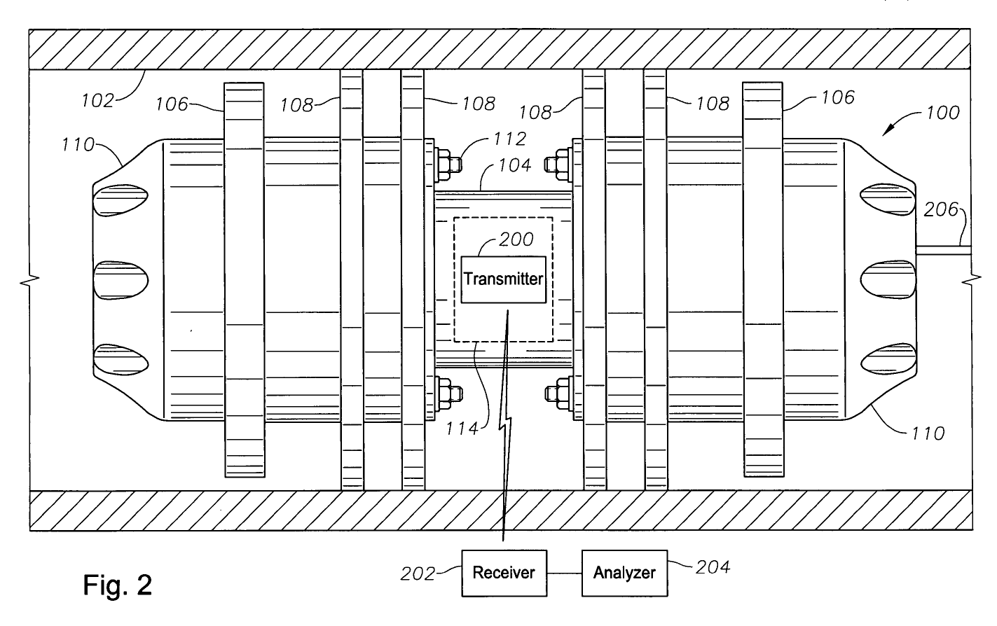

In one embodiment, the collected and/or analyzed data is stored in a storage device of the onboard system 114. Alternatively, as shown in FIG. 2, the onboard system 114 may include a transmitter 200 (or transceiver) configured to transmit information to a remote location at which a receiver (or transceiver, in some embodiments) 202 resides. The received information may then be provided to an analyzer 204. In this manner, the onboard system 114 may perform no processing of the data, or may perform some processing of the data, while the remotely located analyzer 204 performs additional processing.

In one embodiment, the information is provided to an Internet-based server computer (e.g., a Web server). In another embodiment, the information is provided to a wireless-enabled laptop computer. The laptop may be configured with the analyzer 204. To facilitate these and other communications of the data, it is contemplated that the information may, at least in part, be transmitted via satellite or by wireless telephone technologies.

Preferably, the transmitter 200 and transceiver 202 are wireless devices. In one embodiment, a plurality of transceivers 202 (collectively part of a common network) are disposed along the length of the pipeline 102. Each receiver 202 defines an access point at which a communications exchange may occur between the receiver 202 and the transmitter 200. However, in another embodiment, the pig 100 is connected to a tether 206 configured as a transmission medium. By way of example, the tether 206 may include electrically conductive elements (e.g., copper wire) or a fiber optic cable(s).

In any embodiment in which information is exchanged between the pig and one or more other nodes (e.g., the transceivers 202 and the analyzer 204), th information may be filtered at various stages. For example, data filtering may be performed by the pig 100 before transmitting the information to one or more transceivers 202, or at the transceivers 202 before transmitting to the analyzer 204. Filtering the information may effect faster transmission rates.

In addition to transferring information from the pig 100 to remote devices, it is also contemplated that information may be transferred to the pig from remote devices. For example, the transceivers 202 may transmit data to the pig as it passes. The information collected by the pig in this manner may be used to conFIG. the operation of the pig (i.e., to remote control the pig) or may be data collected by other components in the pipe and subsequently be retrieved/uploaded/downloaded for analysis (i.e., after the pig is removed from the pipe or at some other uploading station within the pipe).

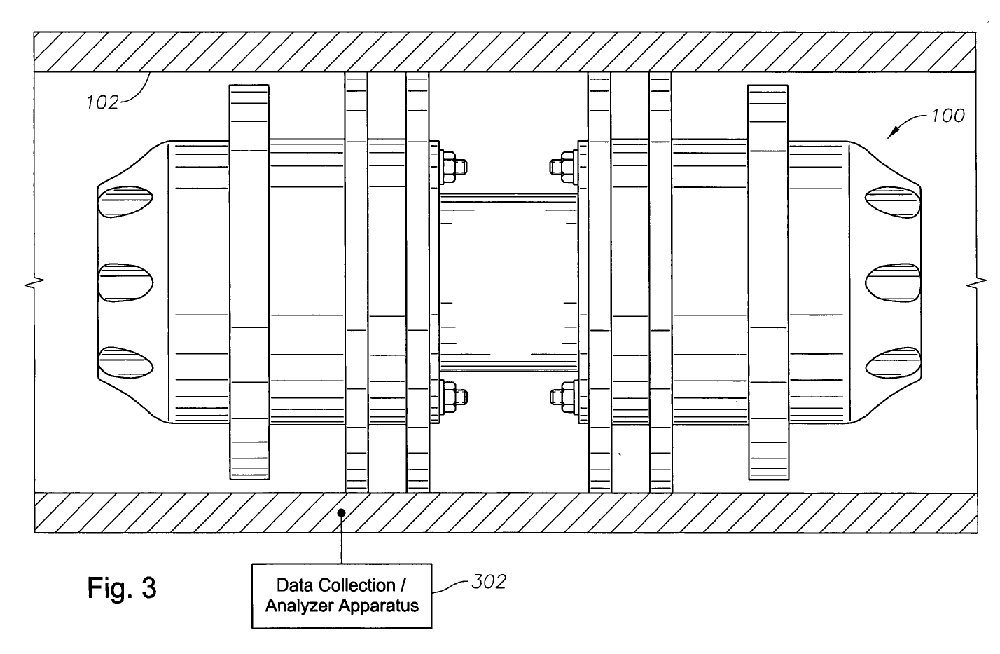

In yet another embodiment, the pig 100 is a “dumb” pig, having no data collection/analysis capabilities. Instead, vibration caused by interference between the inner walls of the pipeline 102 and the pig 100 is captured by a data collection/analyzer apparatus 302 coupled to the pipeline 102, as shown in FIG. 3. To augment the vibration, one embodiment of the pig 100 includes noisemakers. For example, formations may be disposed on the guides 106 or spacers 108 which, upon engaging the inner walls of the pipeline 102, increase the amount of vibration caused by relative movement between the formations and the pipeline 102 than would be possible without formations.

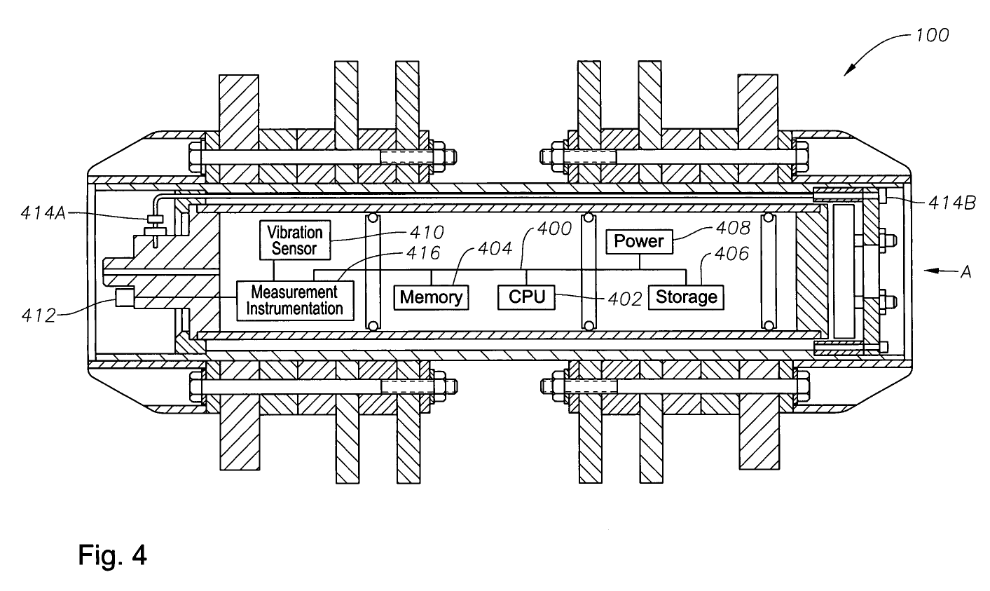

Referring now to FIG. 4, one embodiment of an onboard system 114 is shown. Generally, the onboard system 114 includes a bus line 400 having connected thereto a processor 402, a memory 404, storage 406, and a power supply 408. The onboard system 114 includes one or more sensors selected according to the desired data to be collected. Illustratively, the sensors includes a vibration sensor 410, a temperature sensor 412, and a pair of pressure sensors 414A-B. The sensors may be any variety of known or unknown devices capable of sensing one or more parameters. By way of illustration, the sensors may include accelerometers, strain gauges, fiber optic sensors and the like. In a particular embodiment, the vibration sensor 410 may be an accelerometers, the temperature sensor 412 may be a thermocouple and the pair of pressure sensors 414A-B may be strain gauges (illustratively, one pressure sensor is positioned at either end of the pig 100 to allow determination of a pressure drop across the pig 100). The various sensors may be connected to measurement instrumentation 416 which may include, for example, detectors.

In another embodiment, there may be provided on the pig 100 between the spaced apart guides 106 a probe formed and arranged for contact with the inside wall of the pipeline 102 for measuring the friction between the pipeline pig and the inside of the pipeline and thereby to obtain debris deposit profile for the length of pipeline being measured.

In another embodiment, the pig 100 is equipped with distance and/or position equipment. For example, the pig 100 may be configured with an odometer wheel for detecting the distance traveled by the pig 100. Alternatively or additionally, the pig 100 is provided with timing means. Pipelines are generally made up of a plurality of fixed lengths of pipe, e.g., 12 m, 6 m or 3 m. By “listening” for the joints (i.e., weld points) at which lengths of pipe interface with one another, the speed and the position of the pig 100 may be assessed. As the pig passes a weld, a characteristic change in pig behavior is recorded. Weld-counting software residing on the pig may then be used to count and tag the individual welds. In one embodiment, positional information can be determined by ‘dead reckoning’ to a sufficient degree of accuracy (e.g., to within 6 meters from the nearest weld). Alternatively or additionally, the pig 100 is configured with a global positioning system (GPS).

The pig 100 may also be provided with a gyroscope to give information about the orientation of the pig 100 in a pipeline, such that nosing/tipping or skewing of the pig 100 due to highly localized debris deposits; dents; patches of internal corrosion or other changes in the physical characteristics of the pipeline may be detected, and/or the position of changes in direction of the pipeline recorded.

Persons skilled in the art will recognize any variety of other sensors, configurations and sensing techniques, all of which are within the scope of the present invention. Accordingly, depending upon the particular configuration of the pig 100, any variety of data may be obtained, in addition to vibration data.

In any case, the data collected by the pig can be used to provide information on conditions in the pipeline such as cracks, pits, wall thinning spanning, areas on the inside surface of the pipeline where there is corrosion or debris; partial blockages inside a pipe; leaks from a pipe; damage to pipe cladding; changes in the position of a pipeline or a section of a pipeline due to, for example, spanning; dents or bends in a pipeline as a result of external damage; other flaws in the physical structure to the pipe, feature depths and length, and open/closed valves. In one aspect, the aforesaid examples of pipeline conditions will each exhibit a particular data signature(s) the combination of which will make up the complete pipeline profile.

In the case of the frequency response of the pig, various techniques may be employed to improve the acquisition of meaningful data (in addition to those already described). In general, it is desirable to increase the signal-to-noise ratio. Accordingly, a variety of techniques may be used to filter noise and remove transient events and false positives. For example, certain pipeline condition factors will be known or will be readily recognizable in a pipeline condition profile (generated according to methods of the current invention) such as, for example, the flange joints between sections of pipeline, which will show up on a pipeline condition profile as a series of regularly spaced features. Other recognizable pipeline structures include bends. Such known features may be removed so as to leave a profile of other pipeline conditions. This provides a clearer representation of the frequency response which relates to, for example, any corrosion in the pipeline.

In addition or alternatively to frequency analysis, it is contemplated that the recorded data may be analyzed for recognizable patterns, or signatures. Pattern recognition may be performed by comparing data recorded by the pig 100 to some reference data having a known meaning. That is, the reference data is representative of a known condition, such as the presence of a particular kind of debris (e.g., wax, black powder, corrosion, etc.), abnormal pipe characteristics (e.g., cracks, pits, wall thinning spanning, etc.) or the presence of normal pipe characteristics such as feature depths and length, bends, joints and open/closed valves. Other pipe conditions were described above where it was noted that such pipeline conditions will each exhibit a particular data signature(s) the combination of which will make up the complete pipeline profile. Accordingly, having identified, with a sufficient degree of uniqueness, the particular signatures corresponding to these various conditions, the signatures may be used as reference data for comparison to subsequently recorded data. That is, the recorded data to be analyzed is compared to the reference data to determine whether a recognizable pattern/signature can be identified in the recorded data. Stated differently, the recorded data is analyzed to determine the presence of a pattern/signature matching that of the reference data. Whether the presence of a signature can be established may be dependent on how closely the recorded data resembles the reference data. In one embodiment, it is contemplated that a commercially available pattern recognition algorithm is used to analyze recorded data. Generally, the reference data may be empirically derived (e.g., collected by the pig at some previous time) or may be theoretically derived. The reference data may also be manipulated in some manner to, e.g., accentuate or de-accentuate certain pattern features or to normalize the reference data (e.g., with respect to a particular type of pipe).

Frequency analysis and pattern/signature recognition are merely representative of possible signal analysis techniques that may be employed. Persons skilled in the art will recognize other techniques within the scope of the present invention. Further, it is noted that while various aspects are described herein with respect to achieving a desired frequency response to subsequent analysis, this is done merely for convenience and brevity and not by way of limitation. Accordingly, persons skilled in the art will recognize that embodiments so described may also be applied to pattern recognition and other signal analysis techniques.

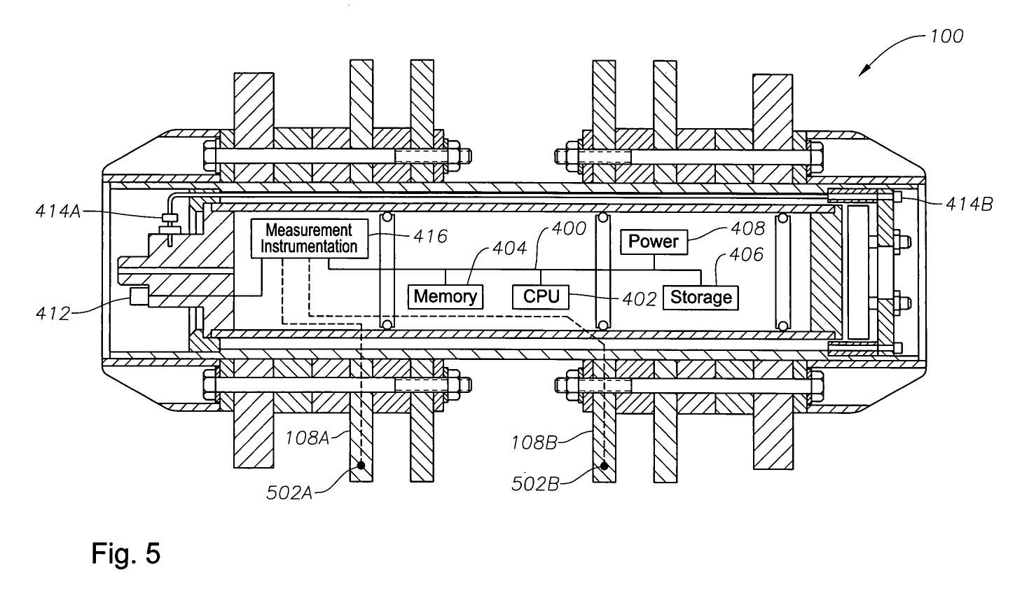

In addition, various techniques may be used to corroborate and/or enhance collected pipeline condition data. For example, temperate data and pressure data may be correlated to the vibration data to confirm the present of particular pipeline conditions. Methods of using various data (e.g., pressure data) are described, for example, in UK Patent Application No. 9620635.4, entitled “PIPELINE CONDITION MONITORING SYSTEM AND APPARATUS” filed Oct. 3, 1996, which is hereby incorporated by reference in its entirety. Further, different pig configurations can be utilized in order to adjust the sensitivity of the pipe condition detection capability or otherwise enhance analysis of the data. For example, the location and number of sensors may be selected according to a desired result. Referring to FIG. 5, an embodiment of the pig 100 is shown in which vibration sensors are located within one or more of the guides 106 or spacers 108. Specifically, a first vibration sensor 502A is located in a first spacer 108A and a second vibration sensor 502B is located in a second spacer 108B. In this manner, the vibration sensors 502A-B may be located more proximate to the source of the vibration. In addition, because each sensor acts as a discrete data collection unit, the information collected by one sensor may be correlated to the information collected by another sensor. For example, assume that the pig 100 is moving in the direction indicated by the arrow labeled “A”. The first sensor 502A may collect data corresponding to physical contact between the first spacer 108A and corrosion within the pipeline. Shortly thereafter, the second sensor 502B may collect data corresponding to physical contact between the spacer second 108B and the same corrosion. The collected data corresponding to the detection events should be substantially similar and, therefore, allow for mutual corroboration. In another aspect, feedback detected by one of the sensors during an event sensed by the other sensor may also be used to advantage. Continuing with the foregoing example, when the first sensor 502A collects data corresponding to physical contact between the respective spacer 108A, the second sensor 502 may also sense the same event (as a result of vibratory energy traveling through the fluid medium, through the pipeline or through the pig itself). Using this information, the existence and characterization of a pipeline condition may be facilitated.

Regarding the physical configuration of the pig 100, in one embodiment the pig guide diameter and/or seal diameter and/or thickness are selected to give a desired frequency response. In particular, the pig guide diameter, seal diameter and thickness can be altered to generate vibration frequency data characteristic of the internal condition of the pipeline.

Additionally, the speed at which the pig is passed along the pipeline is selected to give a desired frequency response. In particular, the speed of the pig can be controlled to within a suitable range to generate vibration frequency data characteristic of the internal condition of the pipeline. In one embodiment, the frequency data is correlated against the position data and/or the speed data to obtain an indication of the condition of the pipeline, particularly, to indicate the location of any corrosion on the pipeline.

The pig 100 could also be provided with sensor systems formed and arranged for sensing the presence of debris independent of any direct physical interaction between the pig itself and the debris. For example, there could be provided non-contact, active, sensing means capable of sensing debris without relying on any physical interaction between the pig itself and the debris, e.g., ultrasonic probe means or radiation sensing means for detecting radiation associated with the debris. The information collected by such sensing means may be then correlated to the data collected by the passive sensing equipment onboard the pig 100.

Further, it will be appreciated that the condition of a pipe and the debris therein will change over time and that a pipeline condition profile obtained for a given length of pipeline with exhibit a different profile from a profile taken some time earlier (or later). It will be understood therefore that by comparing two profiles for a given length of pipeline obtained at separate times, (usually as part of the normal pipe cleaning schedule) it is possible to give an advance warning of a change(s) in pipeline conditions and/or pipeline integrity failure which may be examined in more detail using other intelligent pigging techniques.

Of course, the technique used for identification of a particular condition may depend on the condition itself. Thus, different conditions may be identified using different techniques. For example, identification of wax or debris in the pipeline is carried out by interpretation of the vibration and differential pressure (DP) events. Generally, wax formation in the pipeline produces isolated anomalies in both vibration and DP. These decrease in length and magnitude and become further apart as the quantity of wax in the pipeline decreases. The soft wax can also affect the acceleration trace producing a flat trace with isolated spikes.

Hard wax is normally identified from a low vibration signal coupled with large-scale fluctuations in DP. There may also be a change in the pipeline's temperature gradient. Debris in the pipeline is identified from a build up in DP as the debris builds up in front of the pig, followed by a drop in DP as the pig overcomes the debris. The point where the pig overcomes the debris may cause the pig to pitch resulting in a false out-of-straightness (OOS) feature. In one embodiment, an effective way to confirm the presence of wax or debris in the pipeline is to compare two sets of survey data. This way the anomalies caused by wax or debris will become clear due to their transient nature. It is normal for a wax zone to occur in the same general region over two surveys close together, but with individual anomalies occurring at different locations.

### EXAMPLES

Test Environment

Various tests were performed with a pig configured to collected data representative of the frequency response of a pig. The tests are provided merely by way of example. Persons skilled in the art will recognize that different pig configurations, pipeline characteristics, parameter values, etc. may be used to achieve different results.

The tests were conducted in a loop which allows continuous pigging and includes a removable 6 m spool piece. The pipe used was nominal 10″ seam welded line pipe with 9.3 mm wall thickness (WT). Measurements on this spool suggest that the actual WT was only 8.9 mm. On the assumption that the test spools were similar before the corrosion process began, then the actual metal-loss FIGS. would be 0.4 mm less than quoted here.

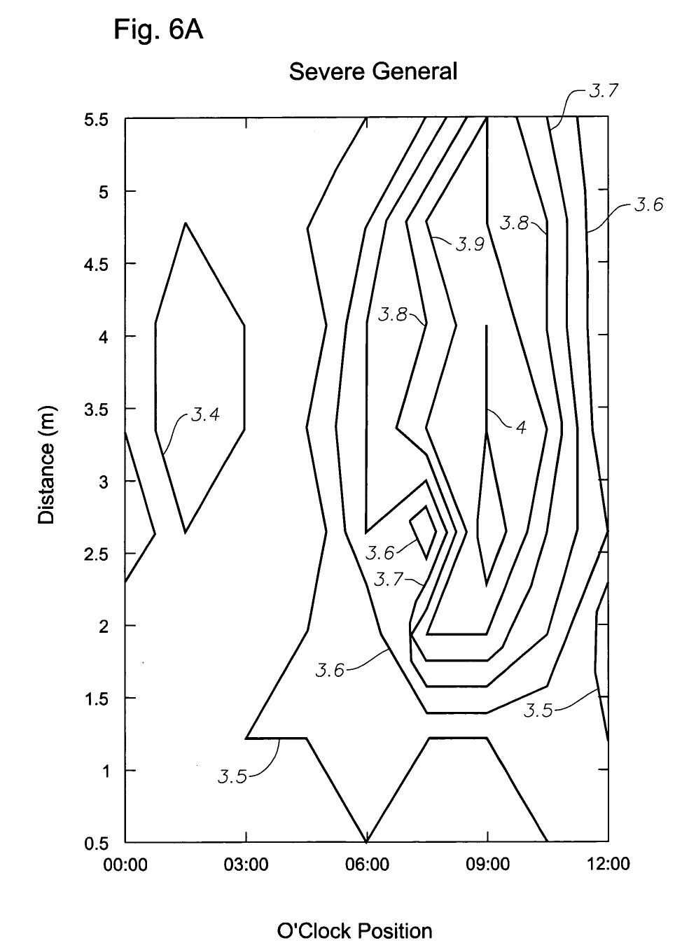

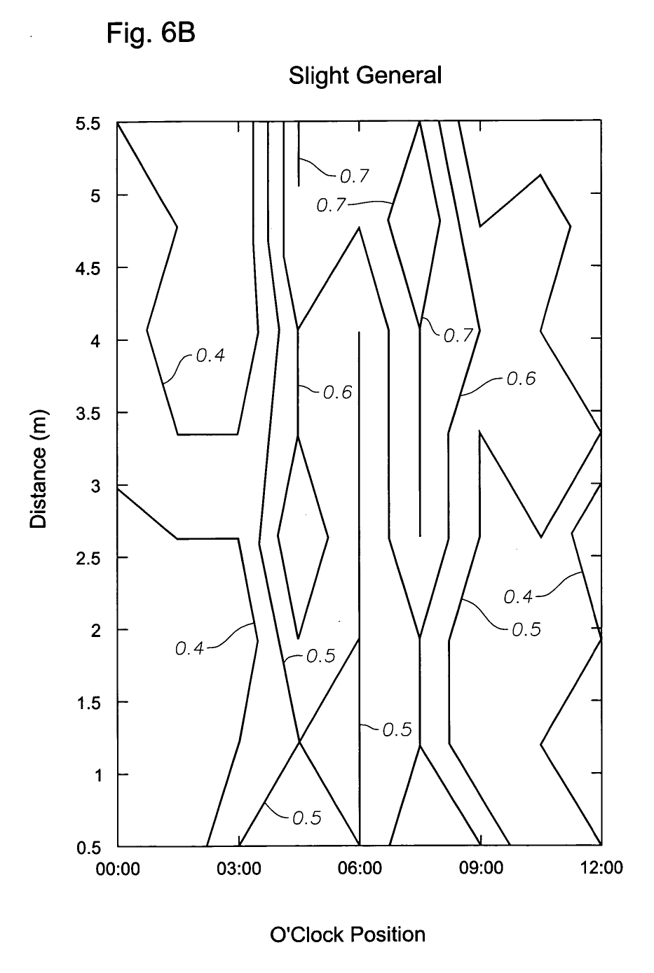

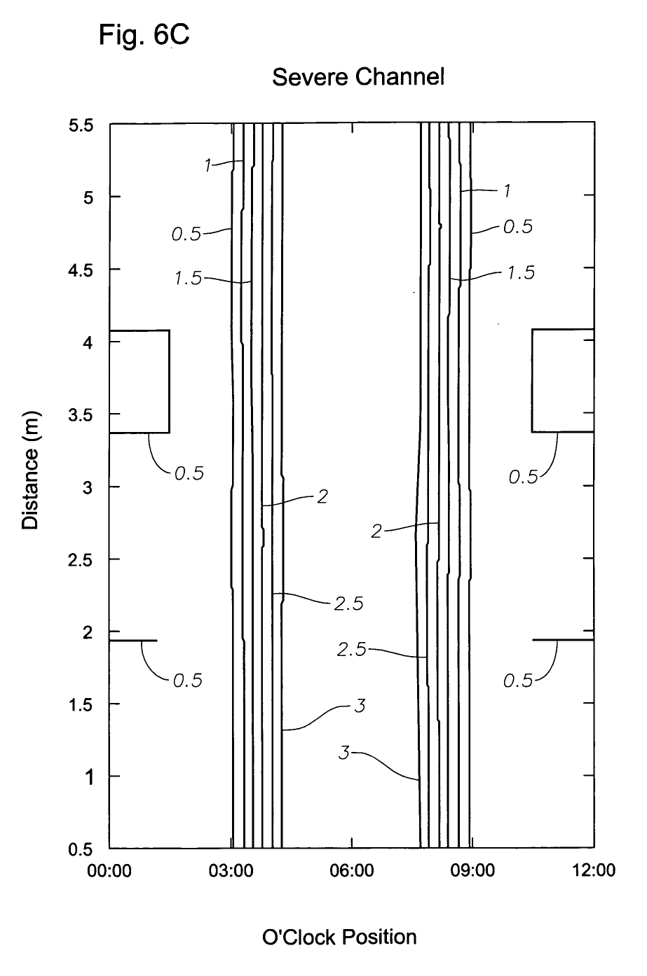

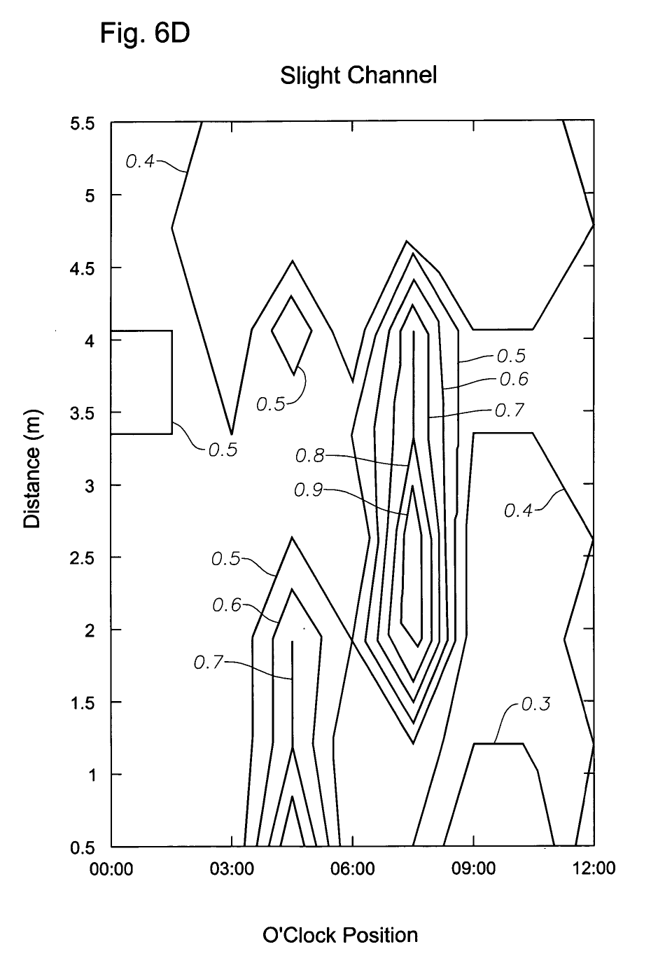

FIG. 6 summarizes the metal loss achieved in each of the four (corroded) test spools. The contours are 0.1 mm apart and represent the total metal loss achieved around the pipe. Measurements were made at eight locations along each spool and at eight positions around the pipeline (the 0130 and 1030 measurements were omitted for the channel corrosion spools). Radial positions are based on looking from the upstream of the test spool, distance is likewise from this end. Four degrees of corrosion were prepared and tested: severe general corrosion, slight general corrosion, severe channel corrosion, slight channel corrosion.

SEVERE GENERAL CORROSION: Accelerated corrosion was achieved by an impressed current method using length of 6.3 mm WT pipe. An approximate metal loss of 0.6 mm was achieved. Overall this was equivalent to 3.6 mm metal loss compared to the un-corroded spool. The metal loss was not particularly evenly distributed across the spool. FIG. 6 shows that the first 1.5 m of the spool has substantially less loss, as does the left-hand side of the spool (between 12 O'clock and 6 O'clock).

SLIGHT GENERAL CORROSION: Accelerated corrosion was achieved by performing an impressed current method using a length of 9.3 mm WT pipe. An approximate metal loss of 0.5 mm was achieved. The corrosion is unevenly spread with the most metal loss at the bottom of the spool and furthest away from the upstream end of the spool. FIG. 6 shows how this pattern differs from the severe general corrosion spool.

SEVERE CHANNEL CORROSION: Initial attempts with accelerated corrosion by an impressed current and crevice method using a length of 9.3 mm WT pipe did not provide the necessary corrosion rate. For this the channel was fabricated by removing a section of the pipe and then welding a section of thinner walled pipe in its place. The channel portion of this pipe was then subsequently corroded by the impressed current method. Approximately 3.4 mm metal loss in a channel 60° wide centered on the 6 o'clock position was achieved.

SLIGHT CHANNEL CORROSION: Accelerated corrosion was achieved by an impressed current and crevice method using a length of 9.3 mm WT pipe. Metal loss was created varying between 0.5 and 1.0 mm in a very irregular channel varying between 20° and 80° wide. The deepest continuous channel is at the 7:30 position. Note that from FIG. 6, this spool is rather closer to the Slight General Corrosion Spool in metal loss than would ideally have been the case.

A standard bi-directional pig was used. As such, the pig used was configured substantially similarly to the pig 100 (shown in FIG. 1) having a body and, on either end, a pair of sealing disks and a guide disk. The pig 100 contained a data acquisition package, sensor package and battery pack. This enabled a range of data to be acquired during each test. The test data was then downloaded and analyzed offline.

Methodology

The pig was configured to collect data at two different frequencies. Pressure, temperature and positioning data is recorded a frequency of approximately 24 Hz (i.e. one reading is recorded from each instrument every 1/24th of a second). The vibration sensor during these tests was sampled at approximately 31 kHz, and digitally anti-aliased at around 12 kHz, in order to suppress spurious effects from high frequencies. The slow (24 Hz) data was used to track the passage of the pig through the test loop and establish the locations of the test-section in the data. Details on the process by which the 31 KHz vibration data is analyzed is included in the attached Appendix A.

The Figures. described below are generated by performing a Discrete Fourier Transform (DFT) on a moving window in the vibration data across the test section. A window of 8192 time-series values was used, each window overlapping the previous by 7168 samples. A Hanning window was used, giving more weight to samples close to the center of the window. Each window represents a length of 10 cm at the slowest speed, rising to 30 cm at the fastest speed. This calculation results in a set of frequency values at a range of times that can be used to represent the data. Once these spectrograms had been generated, the general form of the results was used to guide the development of tools to characterize the data from each of the test spools. The largest differences between tests were seen to lie in the frequency range under 500 Hz. All of the spools showed significant vibration below about 75 Hz, and all had a strong response around 350-400 Hz. For this reason, the frequency band between 75 and 300 Hz was used to characterize each test. For each pass through the test spool, the percentage of power values in the spectrogram above a certain threshold value were calculated. This calculation was repeated for threshold values from 75 dB up 120 dB to create a simple 2-D plot of the response of the tool in each test section for each lap. This also provided an objective way in which to assess the repeatability of the tests. For most of the tests, each lap has a relatively tight group of results for a given speed and threshold values.

Results

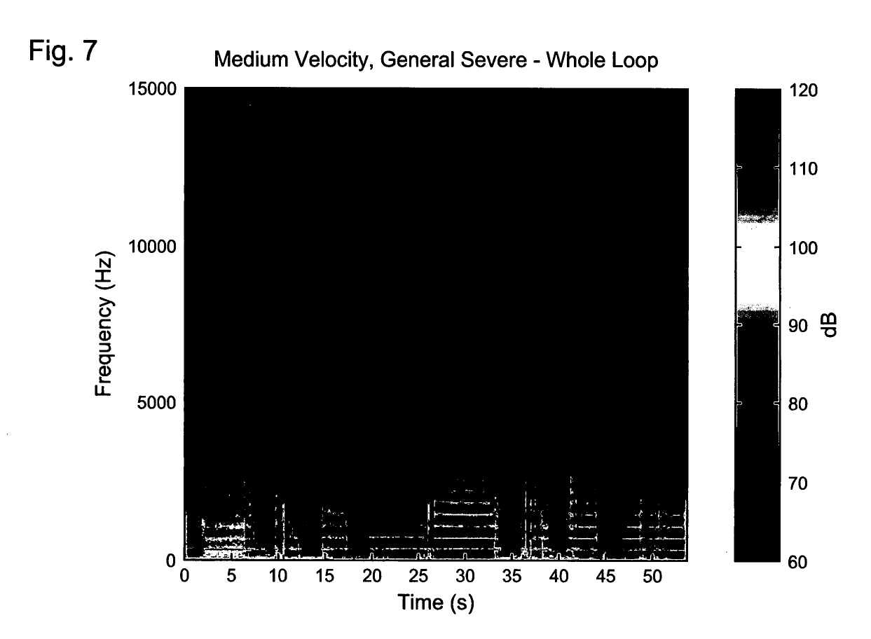

FIGS. 7, 8 and 9 show the spectrograms for a sample loop from Test 1. These are false colour images of the frequency spectra described above. These values are in dB (20 log 10(Spectral Power)). FIG. 7 shows the response for the entire lap across the entire frequency range. The test spool is at the far left hand side, ending at around 7 seconds into the loop. Clear events on this scale include the responses at the bends, where there is very little higher frequency vibration (7-15 seconds and 33-42 seconds). In both cases the response through the valve can be differentiated in the middle of the bend. The regions with very little response at all at 18 and 45 seconds are the locations where the valves change over and the pig momentarily loses drive pressure. A clear set of harmonic responses are visible in the straight sections of pipe, with some sections having more harmonics visible than others. The corroded test section has rather broader lines, and a wide response, in some locations out to around 5 KHz.

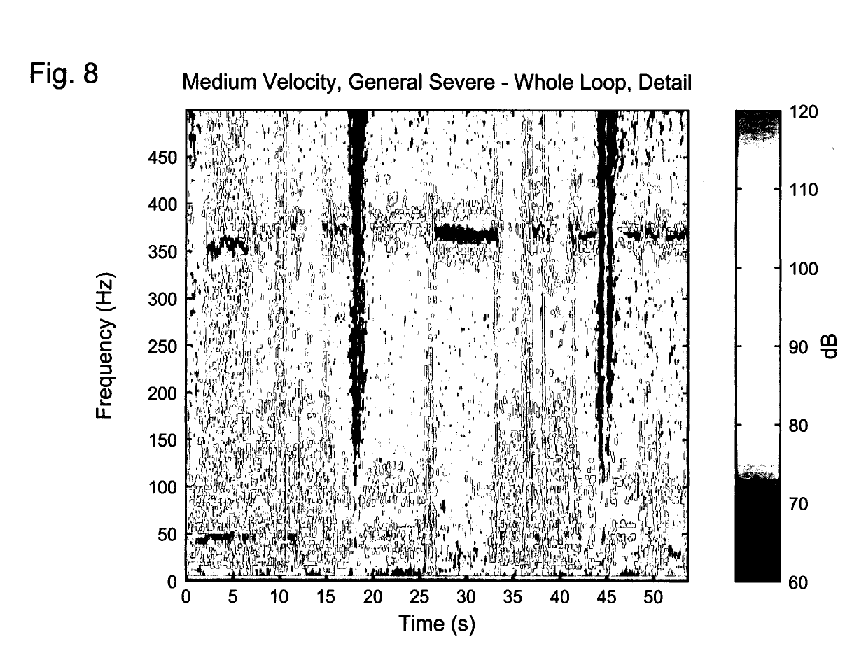

FIG. 8 shows only the low frequency response (under 500 Hz), again for the whole loop. Here the clearest feature is a strong peak at between 350 and 400 Hz, present in all of the straight sections of pipe. This represents the “whistling” noise made by the pig as it goes around the loop, and the frequency is believed to be more characteristic of the test-loop than the pig. It is also this resonance that generates the harmonics visible in FIG. 7. The presence of a wide band response in the test-spool that is not present elsewhere is very clear in this figure, extending out to relatively high frequencies.

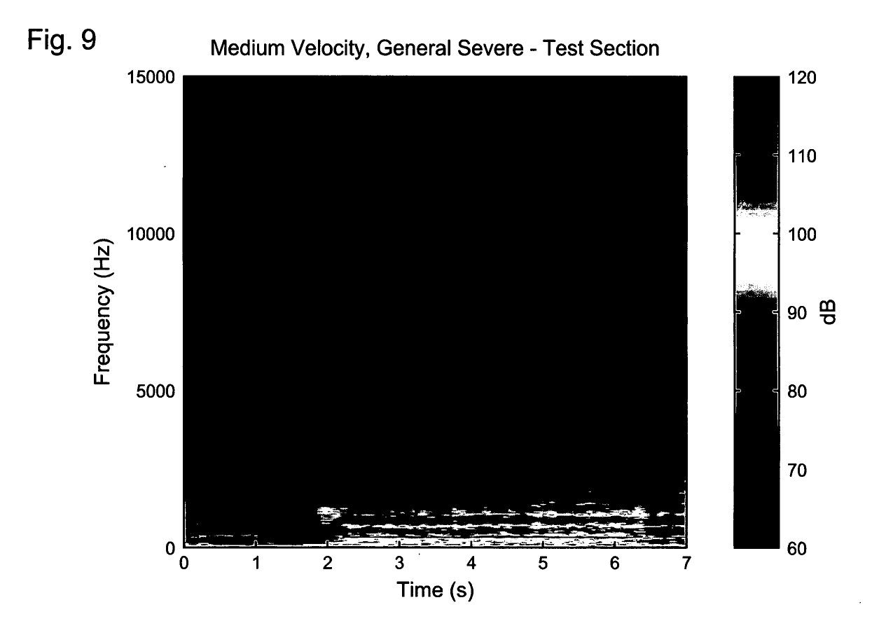

FIG. 9 shows the whole frequency response for the test-spool only. Again the pattern of resonances out to about 1200 Hz can be seen, together with the broad response. The responses right out to 5 KHz that can be seen near the beginning and end of the plot are the pig disks hitting the flanges at either end of the test-spool.

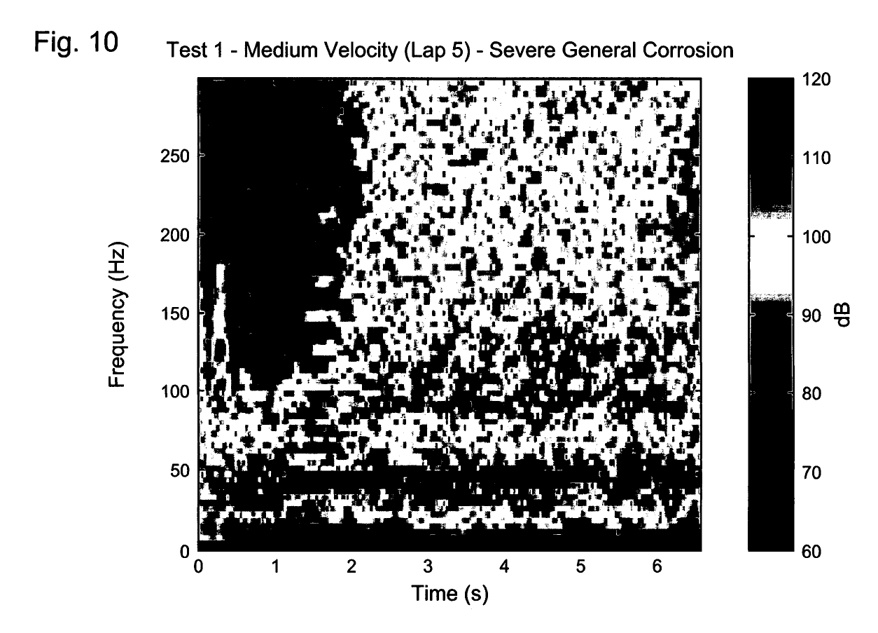

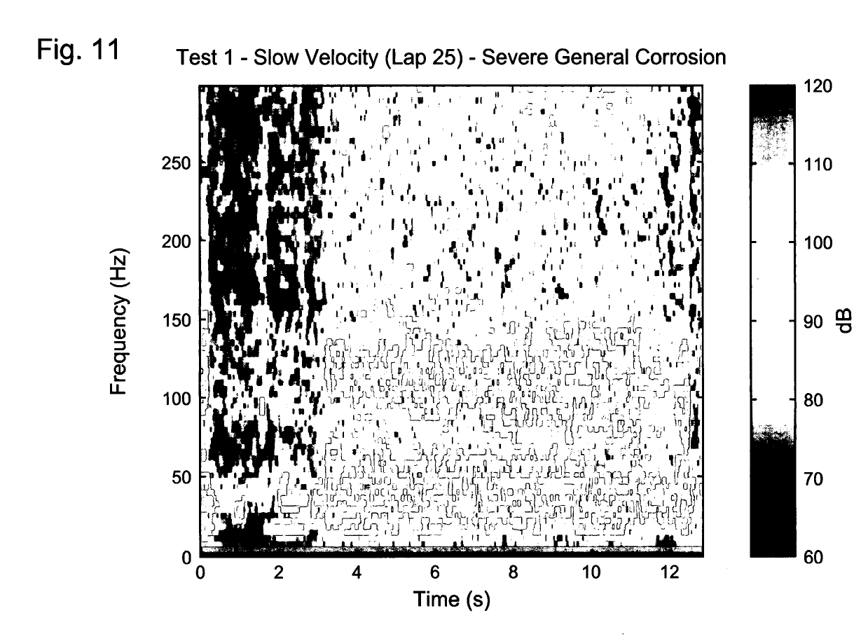

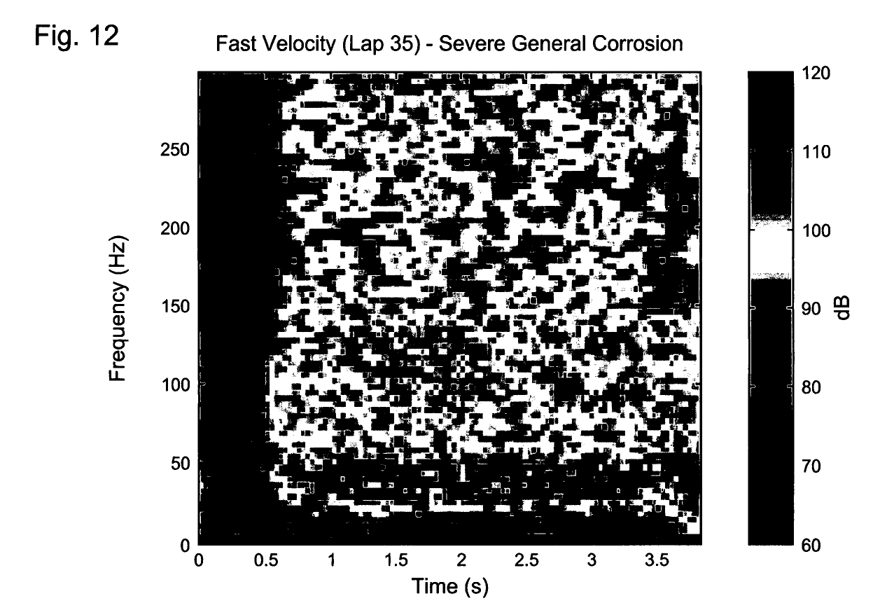

FIGS. 10, 11, 12 show the detailed responses for Loops 5, 25, and 35 of Test 1. These represent the Medium, Slow and Fast speeds respectively (0.8, 0.4 and 1.2 m/s approximately). All of these have the same scales.

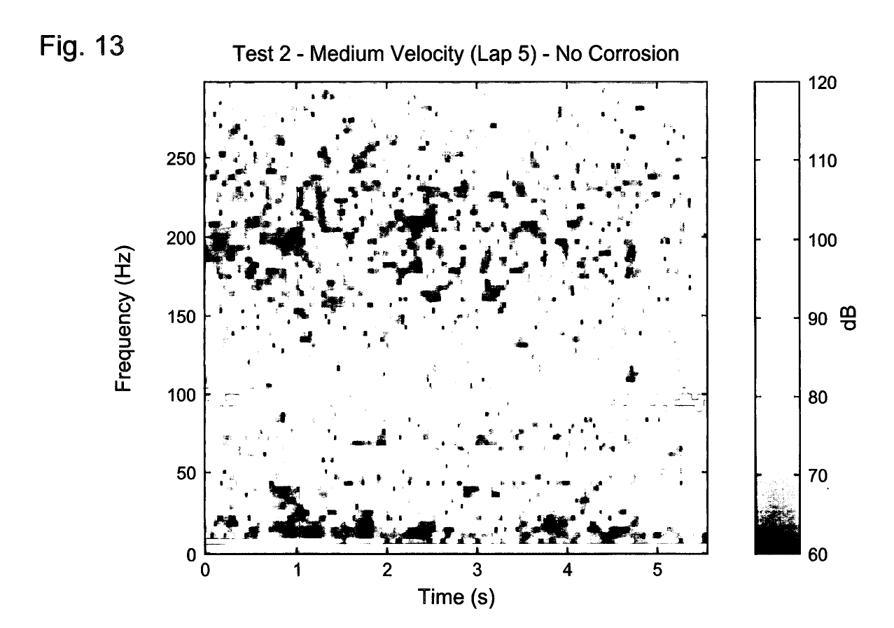

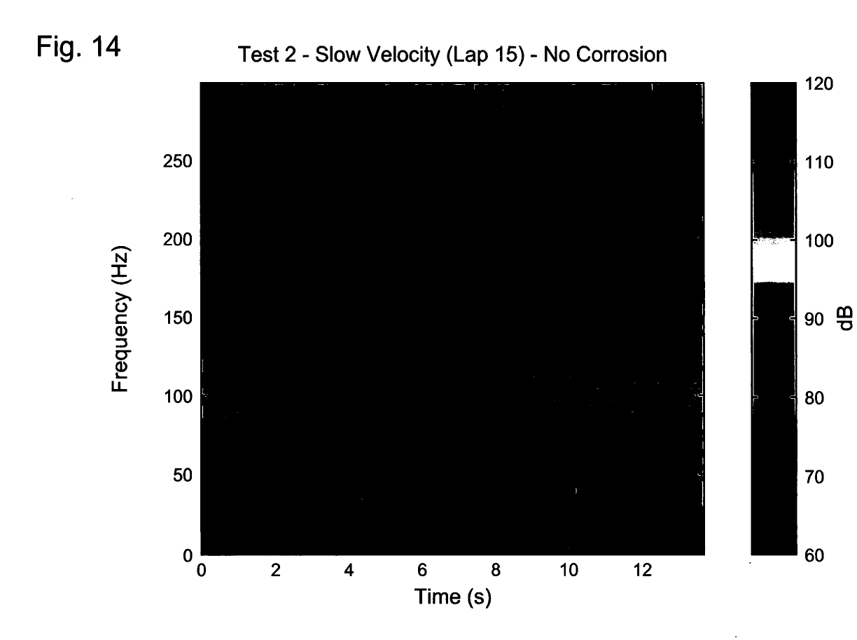

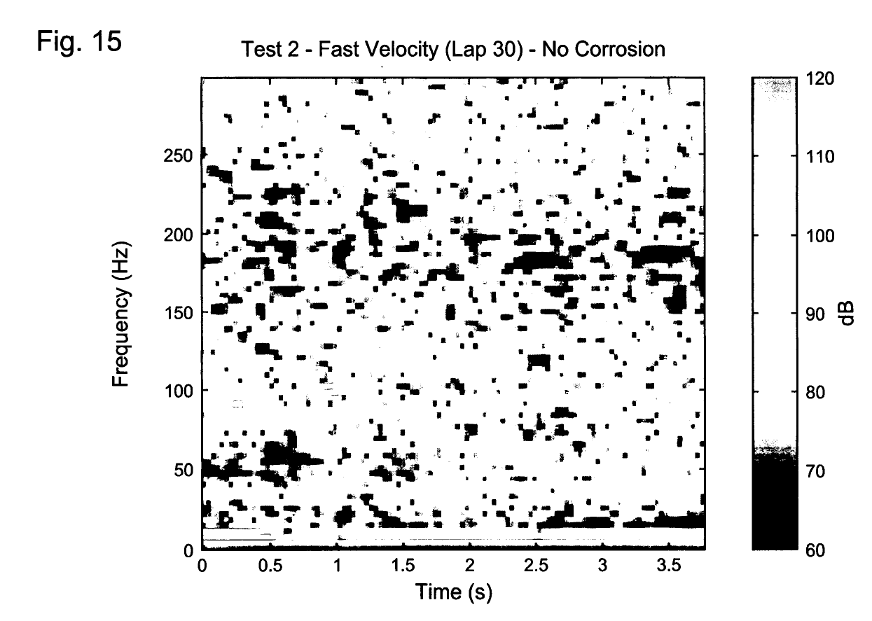

Clear in all three of these plots is a region of approximately a quarter of the length of the spool at the start that has relatively little vibration. Examination of the test-spool shows that this is related to the relative levels of corrosion in the pipe, due to the way in which the corrosion was generated. It is in fact the case that approximately the first 1.5 m of the spool has only relatively light corrosion. Generally, the faster the pig was traveling the higher the vibration levels. On the other hand, comparing these three FIGS. to FIGS. 13, 14 and 15 which show three laps (again one at each velocity) in the un-corroded spool, there is no significant response in this case at any velocity.

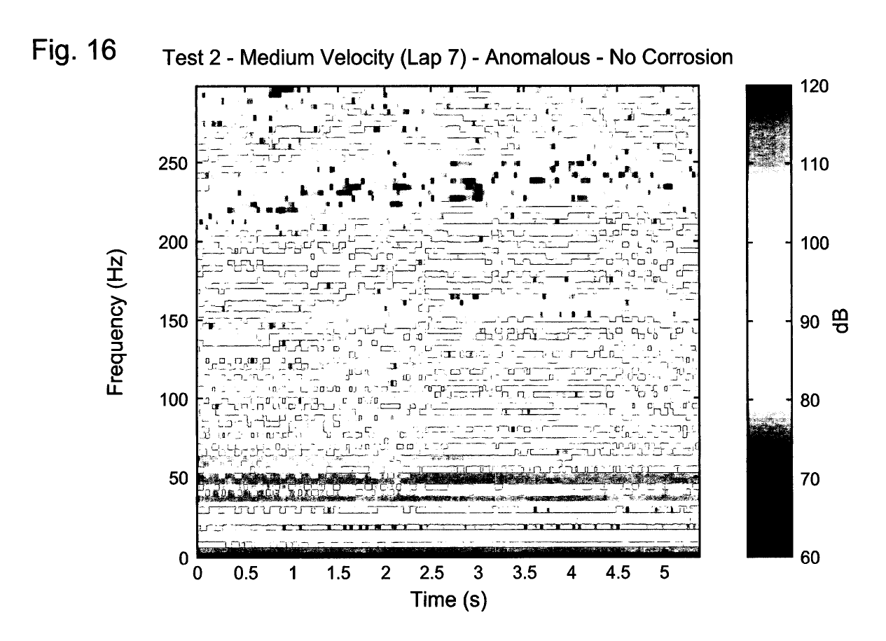

FIG. 16 shows an anomalous response in the un-corroded spool. Out of the test's 34 loops, four show this response, all at either the medium of fast speed. This response is also clearly different from the corroded response, consisting as it does of a number of bands containing this peaks at frequencies 10-15 Hz apart.

Based on FIGS. 10 to 15, it was determined that a statistical analysis of the frequency region on these plots between 75 and 300 Hz was the best way to characterize the pig response in a simple way. The lower frequency was chosen to exclude the 50 Hz response which is sometimes present in the un-corroded spool, and the upper frequency to avoid the large peak usually present in all tests between 350 and 400 Hz. The technique used was to estimate the area on the spectrogram that lies above a given level. Table 1 summarizes the outcomes of all of the tests.

Referring to Table 1, the Severe General Corrosion spool has the highest response for almost all of the pig configurations and speeds. All of the pig configurations show quite significant dependence on the pigging velocity. There are also relatively significant differences in the response between the various pig configurations. For example, the results indicate that the seal diameter has a major effect on the vibration response of the pig. In one aspect, it is believed that the smaller the seal oversize, the larger the difference in response between corroded and un-corroded test spools. These issues are discussed in more detail below.

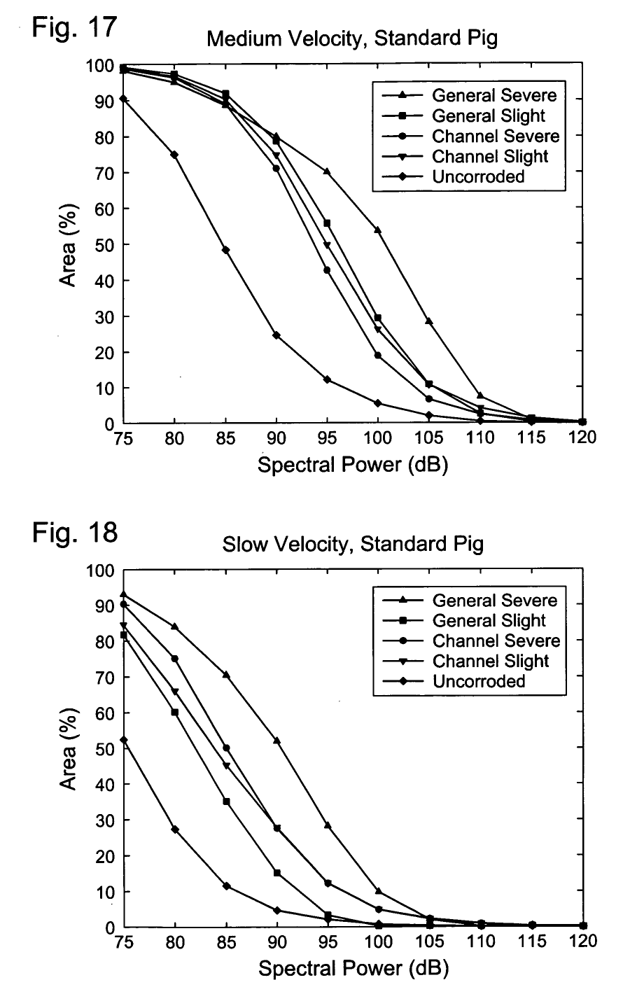

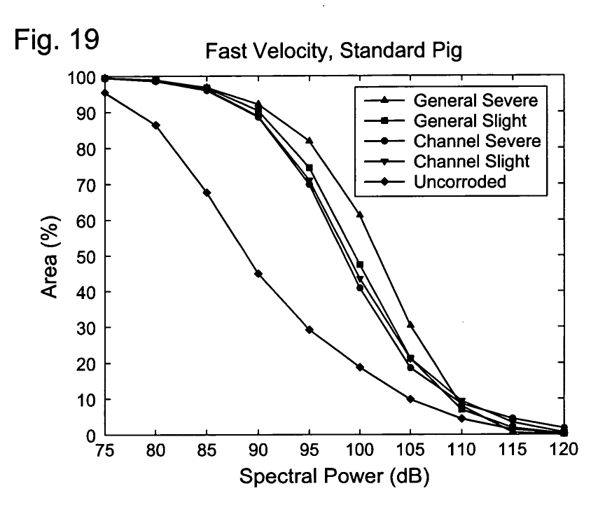

Five tests were performed with the standard pig configuration, and the five test spools. FIGS. 17, 18 and 19 show the outcomes of these tests. These are the mean percentages of the frequency response lying above the given power level. As expected these are all s-shaped curves, with the region of interest generally lying between 75 and 120 dB. At the medium velocity, the General Severe Corrosion spool can be clearly distinguished from the others, as can the un-corroded spool. The General Slight, Channel Severe and Channel slight all lie relatively close together. The slow velocity plot shows the same pattern, although all lines are shifted over to the left, reflecting the fact that there is generally less vibration at the lower velocity. In the fast tests, all lines are shifted to the right, but in this case the General Slight and Channel spool responses have moved towards the General Severe.

Tests were performed in the general severe, channel severe and un-corroded spool with a variety of pig configurations. A total of 9 configurations were tested, as shown in the test matrix below (Table 1).

TABLE 1

| Test | | | |
|---|---|---|---|
| No. | Spool | Pig | Comments |
| 1 | General | Standard | Spool has significant response between 50 and 300 Hz, except during the |
| | Severe | | first 1-3 m The slowest velocity shows a band of response around 120 Hz. |
| 2 | Uncorroded | Standard | Spool shows little or no response except for a few anomalous laps |
| 3 | General | Standard | Spool shows a response between 50 and 300 Hz. rather less than the |
| | Slight | | General Severe spool The difference is less at high velocities. |
| 4 | Channel | Standard | The spool shows a similar response to the General Slight spool and can be |
| | Severe | | differentiated only by the DP response. |
| 5 | Channel | Standard | The spool shows a similar response to the General Slight spool, and can be |
| | Slight | | differentiated only by the DP response |
| 6 | General | Small Seal | This spool shows significantly greater response than the standard at the |
| | Severe | | lower velocities. |
| 7 | General | Large Seal | This configuration has a greater response than the standard pig at the |
| | Severe | | lowest velocity, but is very similar at higher velocities. |
| 8 | General | Thin Seal | Not Performed |
| | Severe | | |
| 9 | General | Thick Seal | Similar to the standard pig |
| | Severe | | |
| 10 | General | Small | Similar to the standard pig |
| | Severe | Guide | |
| 11 | General | Thin | Has a greater response than the standard pig particularly at the lowest |
| | Severe | Guide | velocity |
| 12 | General | Long | Has a greater response than the standard pig at the lowest velocity only |
| | Severe | | |
| 13 | General | Large | Has a significantly lower response than the standard pig at all speeds |
| | Severe | Spacer | |
| 14 | General | Heavy | Has a somewhat lower response than the standard pig except at the |
| | Severe | | slowest velocity |
| 15 | General | N/A | Not Performed |
| | Severe | | |
| 16 | General | N/A | Not Performed |
| | Severe | | |
| 17 | General | N/A | Not Performed |
| | Severe | | |
| 18 | Channel | Small Seal | Has a significantly higher response than the standard configuration, and |
| | Severe | | overall a similar response as in the Severe General Corrosion spool |
| 19 | Channel | Large Seal | Has a similar response to the standard pig, and a lower response than in |
| | Severe | | the Severe General spool at all velocities |
| 20 | Channel | Thin Seal | Not Performed |
| | Severe | | |
| 21 | Channel | Thick Seal | Has a significantly larger response than the standard pig, but a similar |
| | Severe | | response to the Severe General spool |
| 22 | Channel | Small | Has a smaller response to the standard pig at high velocity, about the same |
| | Severe | Guide | at the medium velocity, and higher at the slow velocity. Lower response |
| | | | than in the Severe General spool at all velocities. |
| 23 | Channel | Thin | Very similar to the Small Guide pig |
| | Severe | Guide | |
| 24 | Channel | Long | Has a greater response than the standard pig at the slowest velocity, but is |
| | Severe | | similar at the higher velocities. |
| 25 | Channel | Large | Has a greater response than the standard pig, with the difference being |
| | Severe | Spacer | greatest at the lowest velocity. |
| 26 | Channel | Heavy | Has a greater response than the standard pig at the slowest speed. but less |
| | Severe | | response at the other speeds. |
| 27 | Uncorroded | Small Seal | Has a similar response to the standard pig at all speeds Much lower |
| | | | response than the corroded spools at all speeds. |
| 28 | Uncorroded | Large Seal | Has a response that is highly dependent on the speed Response is even |
| | | | higher than the Severe Corroded spool at the highest velocity |
| 29 | Uncorroded | Thin Seal | Not Performed |
| 30 | Uncorroded | Thick Seal | Has a similar response to the standard pig at all speeds except the highest. |
| | | | Lower response than the corroded spools at all speeds. |
| 31 | Uncorroded | Small | Highly speed dependent. Lower response than the corroded spools at all |
| | | Guide | velocities. |
| 32 | Uncorroded | Thin Guide | Similar response to the Small Guide case. Some evidence that the worn |
| | | | state of the sealing disks has altered the response of the pig. |
| 33 | Uncorroded | Long | Large response at lowest velocity, more similar to the other pig |
| | | | configurations at the faster speeds. |
| 34 | Uncorroded | Large | Low response at all velocities |
| | | Spacer | |
| 35 | Uncorroded | Heavy | Low response at slowest speed, normal at other velocities |

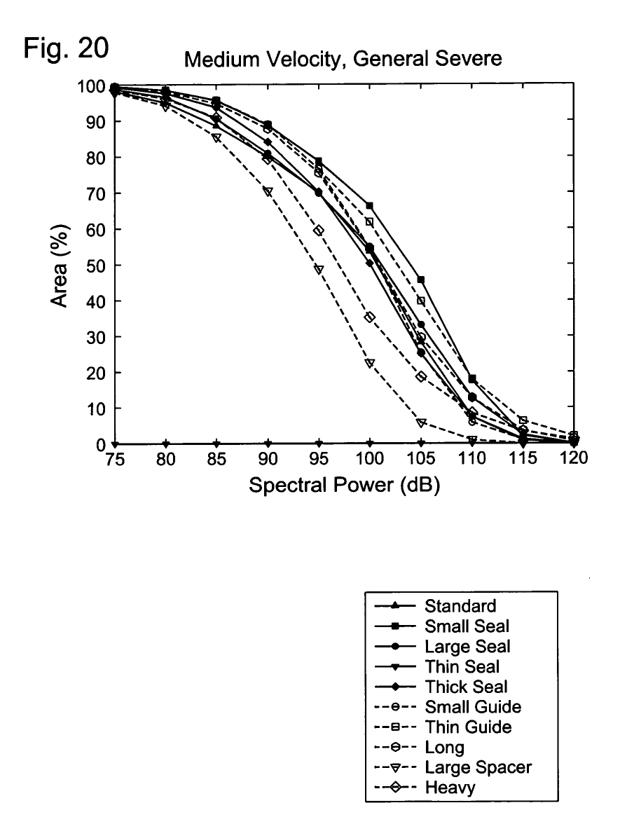

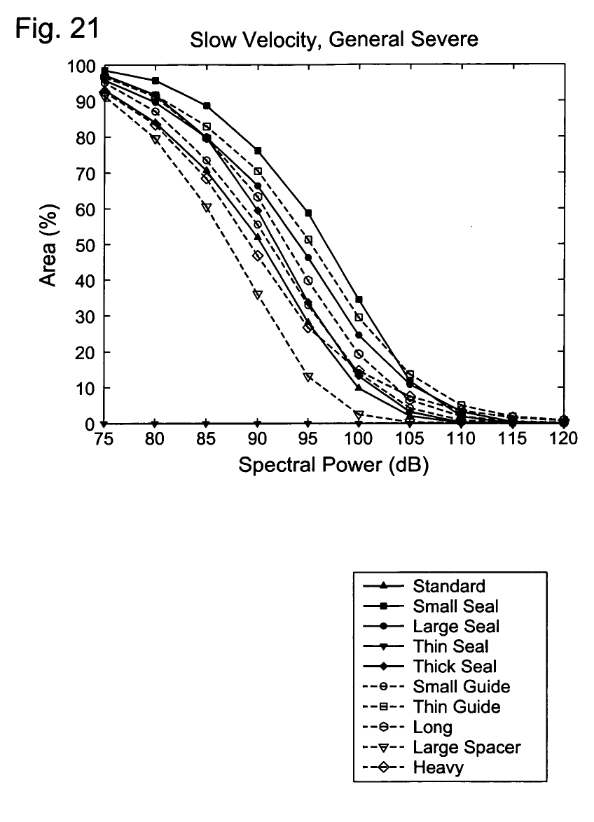

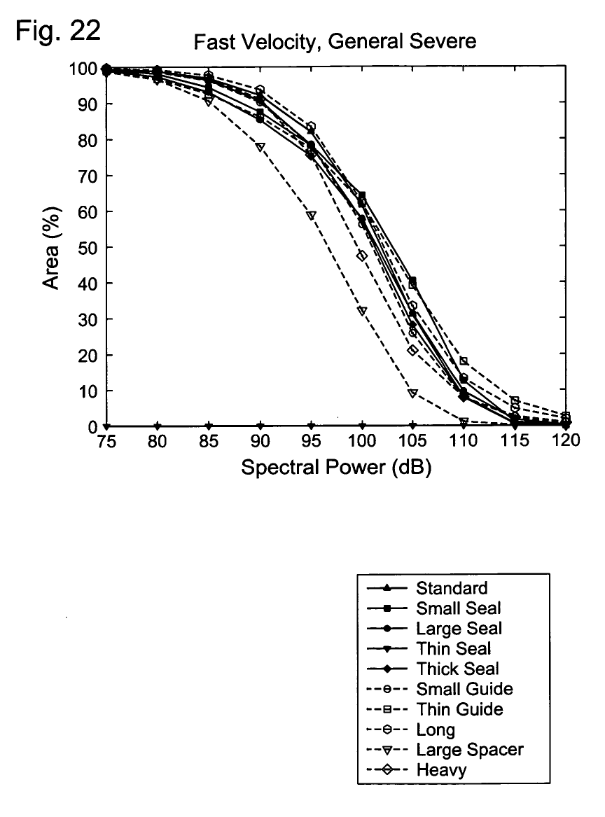

FIGS. 20, 21 and 22 show the responses for the general severe corrosion spool for each of the pig configurations. At the medium and fast velocities, the lines are grouped together quite tightly, indicating relatively little dependence on the pig configuration. This is particularly the case for the fast velocity. The only exceptions to this are the pig with the large spacer diameter, and the heavy pig, both of which show less response. In the slow tests, the range or responses is much wider, although the large spacer pig still had the lowest response. Overall, the pig with the small diameter seals gives the highest response.

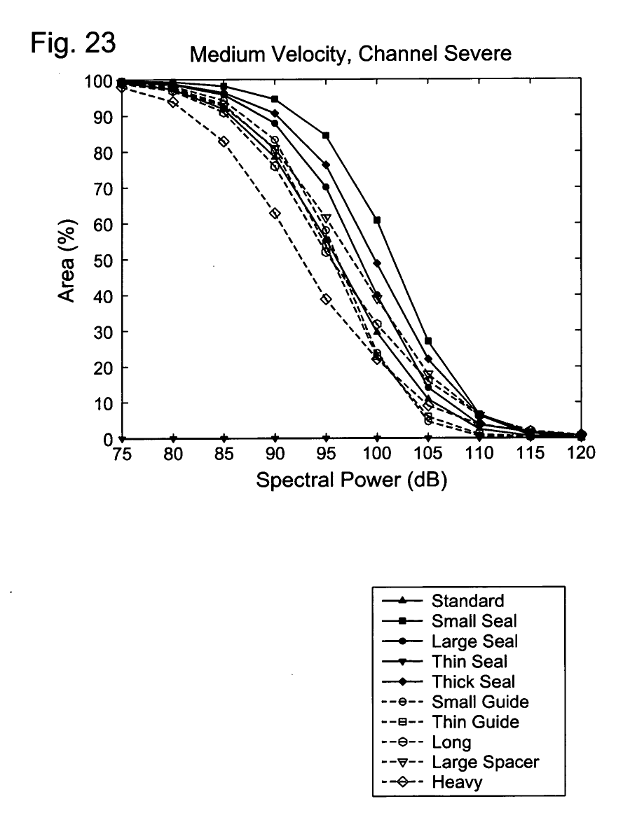

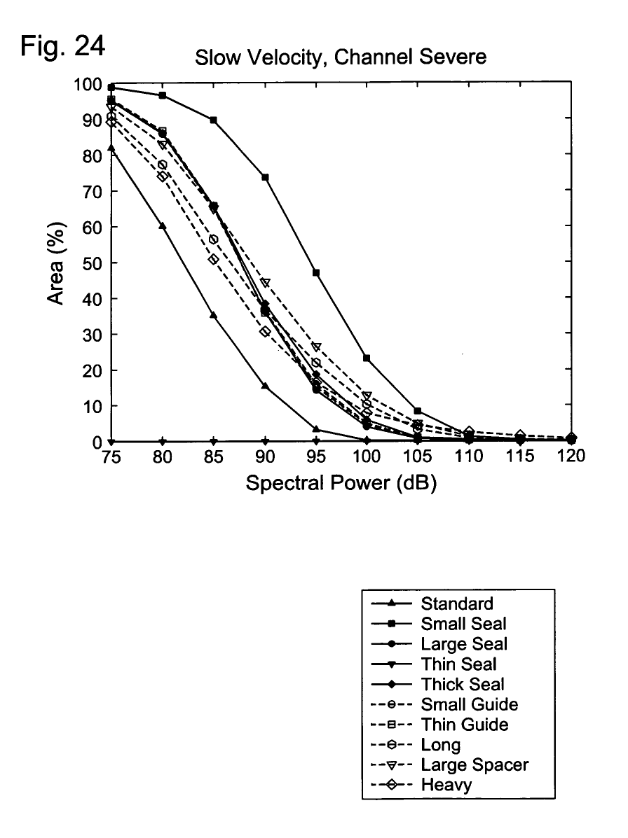

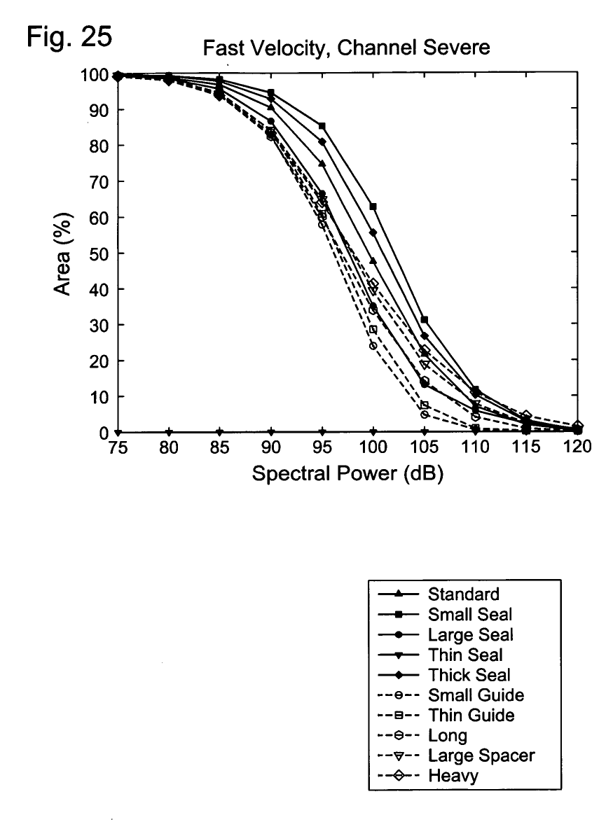

FIGS. 23, 24 and 25 show the responses for the channel severe corrosion spool for each of the pig configurations. Again the pig with the small diameter seals gives the largest response. In this case however, the responses are only roughly grouped together at the fastest speed and are widely spread at the lower velocities. These responses are of a similar magnitude to the responses in the slight general corrosion spool. Examination of the data sampled at 24 Hz suggests that the differential pressure (DP) across the pig during the transit of this spool is different to that in the slight general corrosion spool. The DP shows a distinct pattern of peaks and troughs across the spool (two peaks and three troughs, at the same places each time round the loop). The difference between the peaks and troughs is about 0.1 bar.

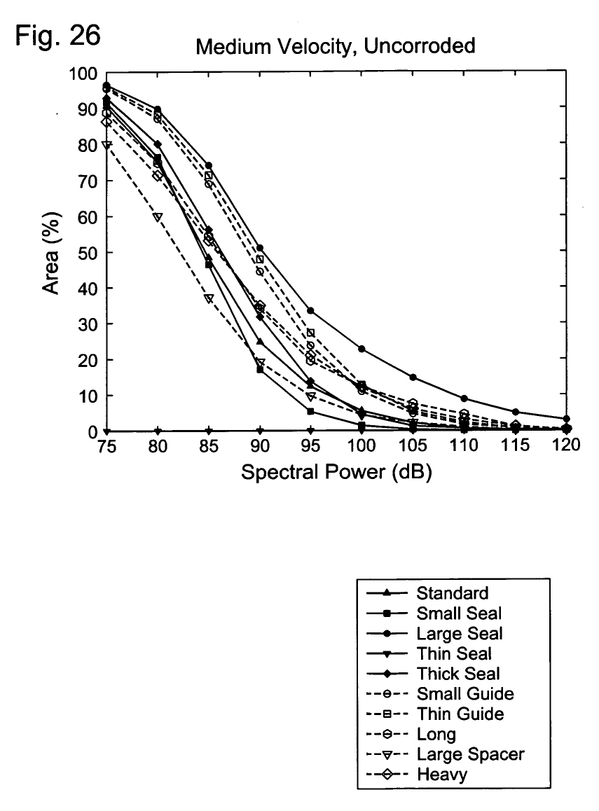

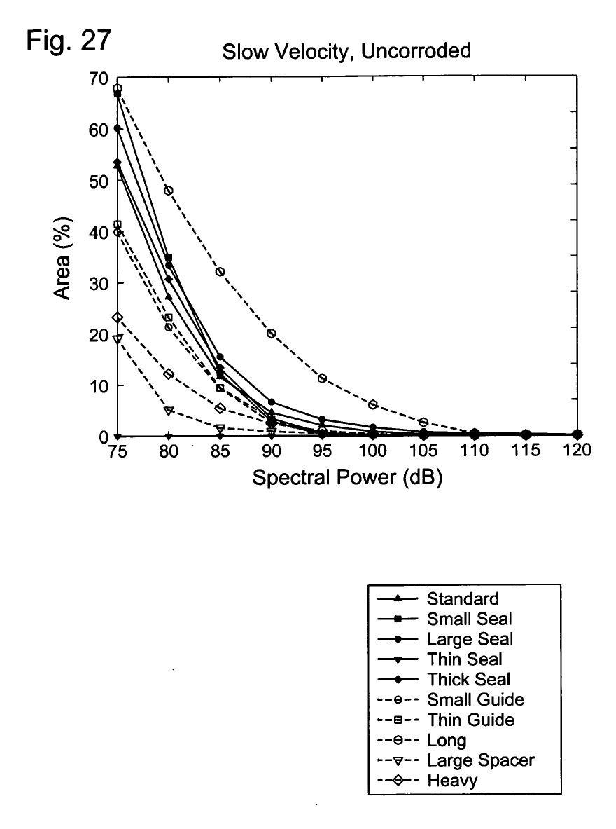

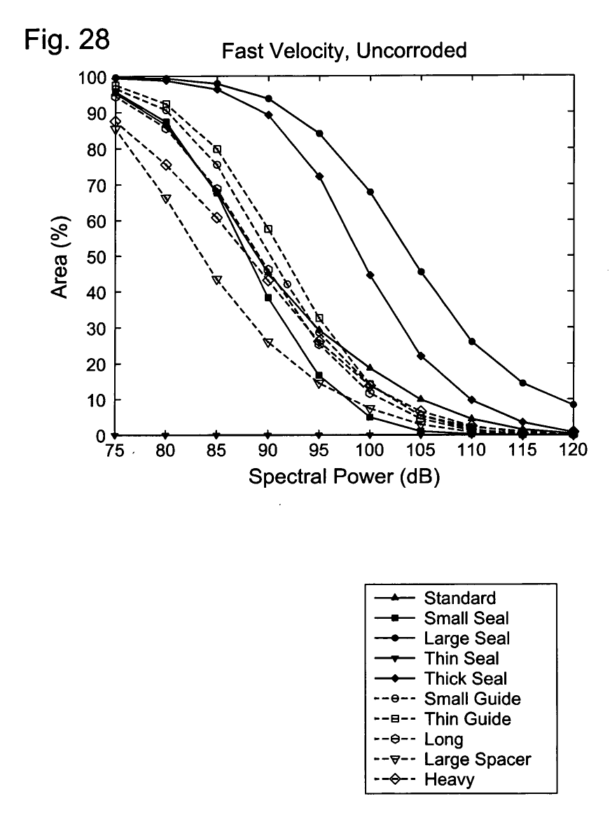

FIGS. 26, 27 and 28 show the responses in the un-corroded (control) spool. These show the opposite behavior to the two corroded spools, with the responses being tightly grouped at the lowest velocity, becoming widely spread at the highest. This is particularly true for the large seal pig, where the response is highly dependent on the speed, being greater than that found in the Severe General corrosion spool at the highest velocity. The final four tests (32-35) show some signs of being affected by disk wear. The main symptom is that the major peak in vibration, which is in the region of 350 to 400 Hz for most of the tests, is shifted downward significantly. This may result in the response values calculated for these tests being rather high.

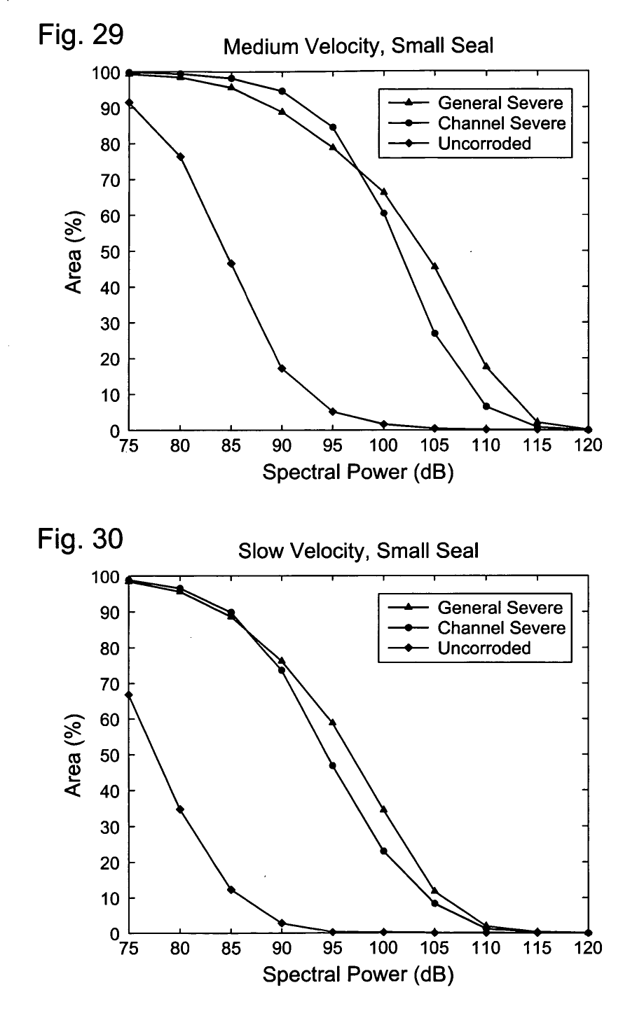

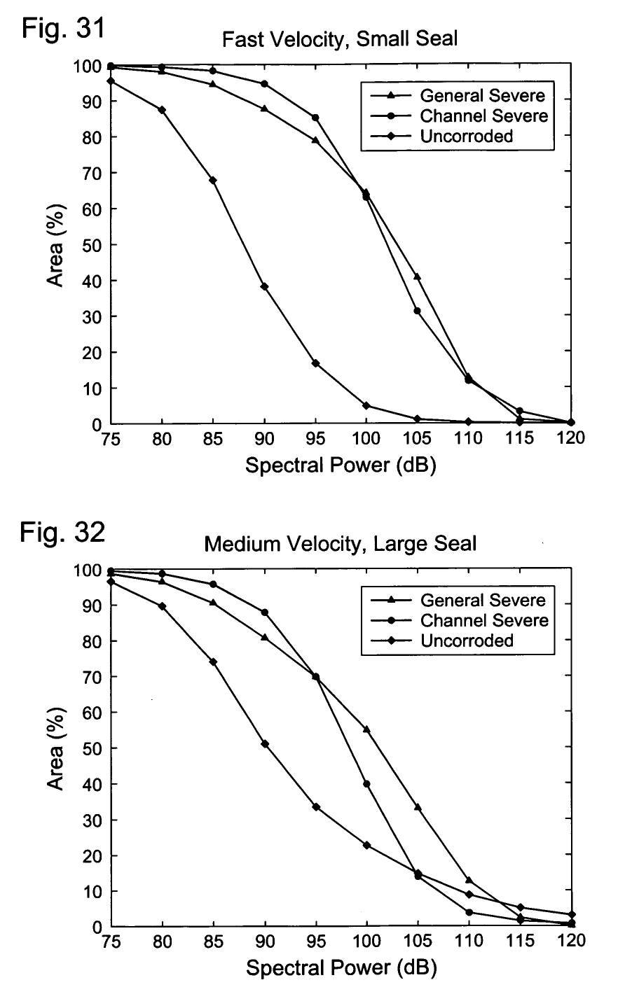

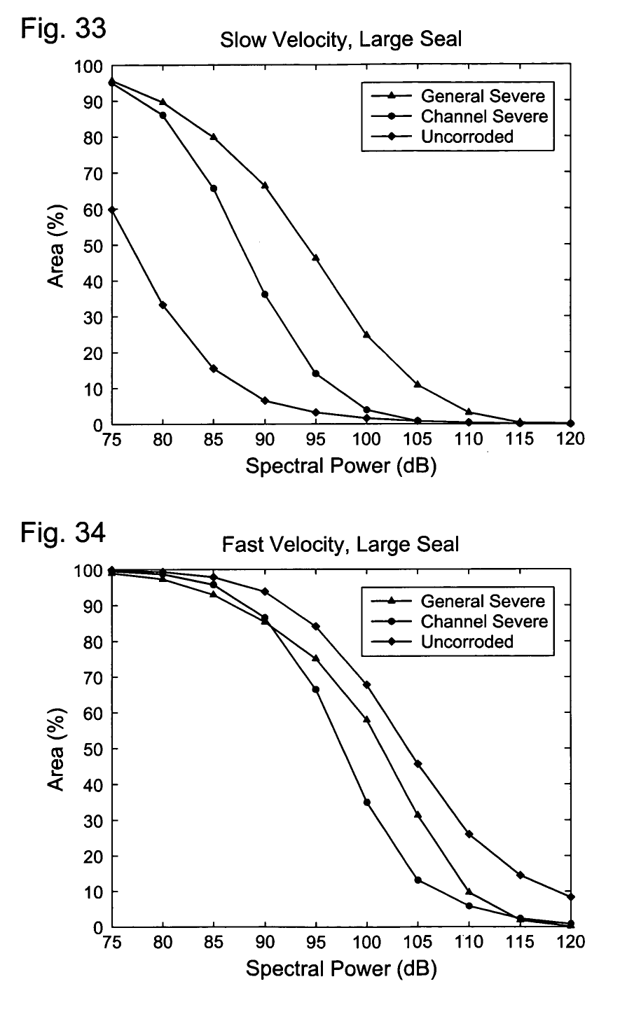

FIGS. 29, 30 and 31 show the response for the small diameter seal pig in three of the test spools. In all three cases the general severe and channel severe have similar responses, with the un-corroded spool having a much lower one. FIGS. 32, 33 and 34 show the responses for the Large Diameter seal pig in three of the test spools. The difference here between the corroded and un-corroded spools is much smaller, and at the highest speed the un-corroded spool actually has the highest response.

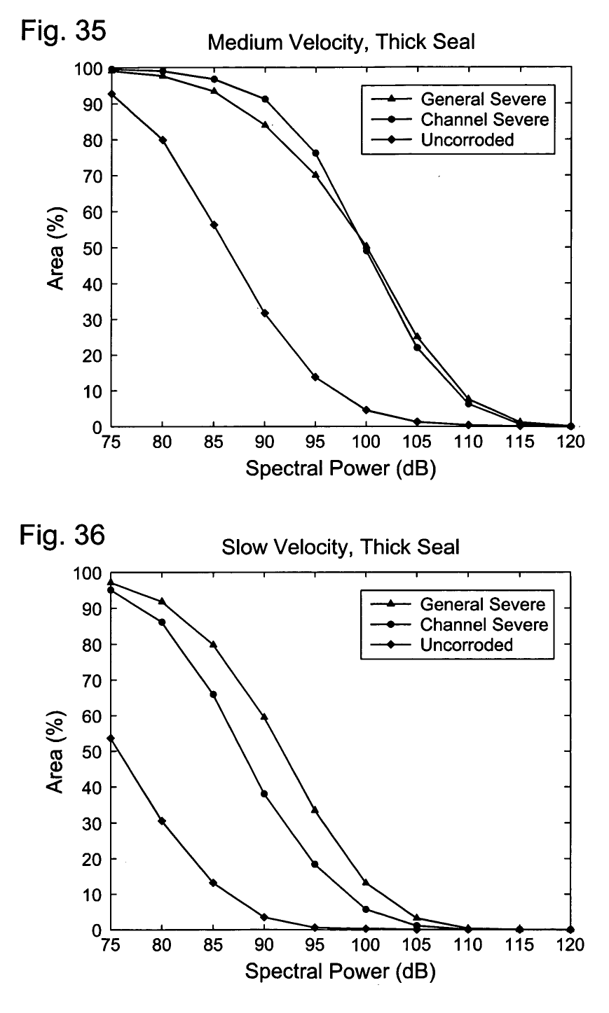

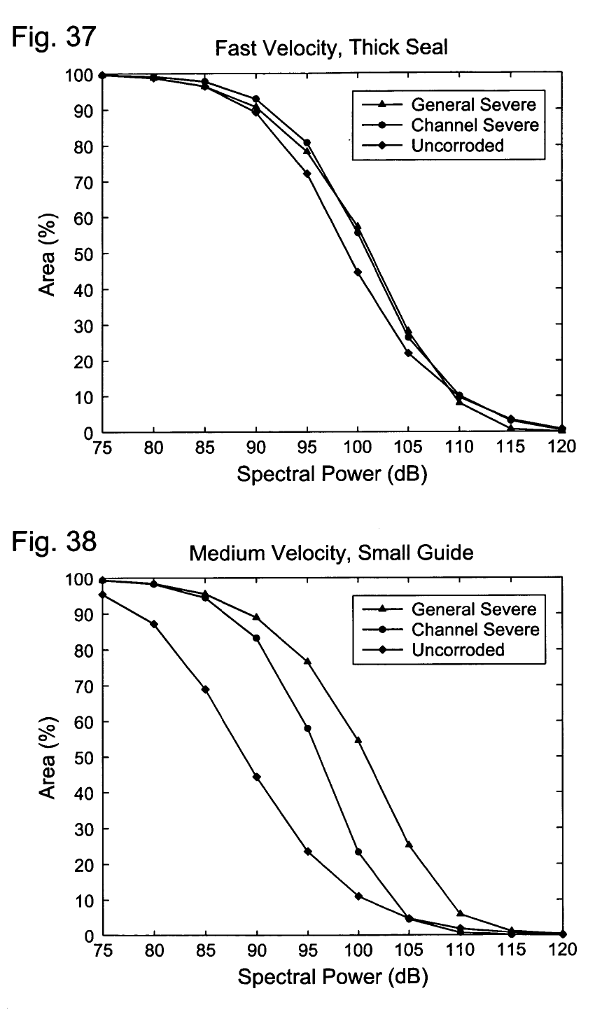

FIGS. 35, 36 and 37 show the response for the thick seal pig in three of the test spools. Again, the two corroded spools are quite close together in their response, particularly at the fast velocity. The un-corroded spool has a lower response at the slow and medium velocity, but has a similar response to the other two spools at the highest speed.

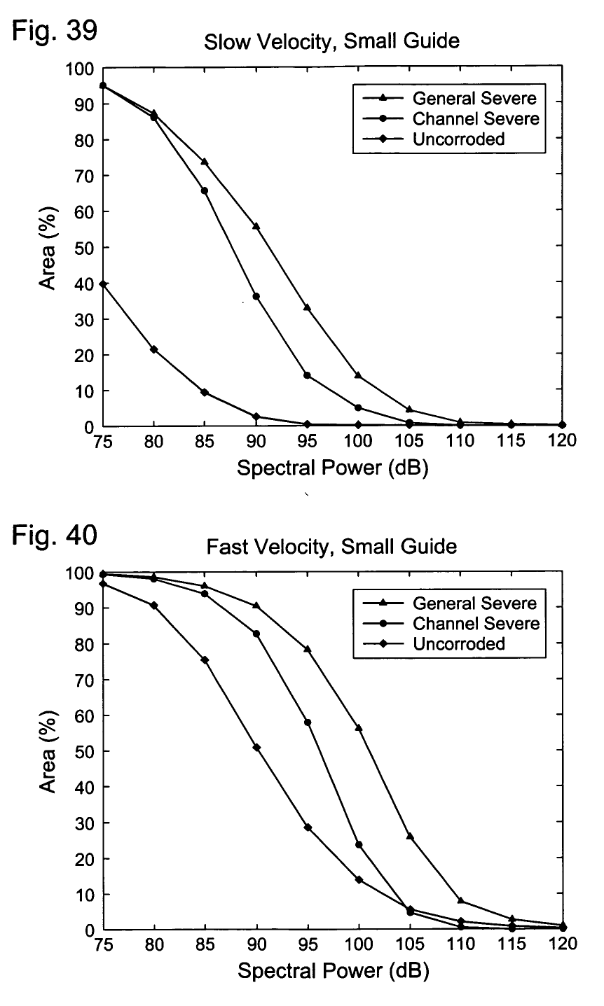

FIGS. 38, 39 and 40 show the response for the small guide disk pig in three of the test spools. Again, the two corroded spools have higher responses than the un-corroded spool, but in this case there is a difference between the two corroded spools. This pig configuration was one of the most sensitive to variation in velocity.

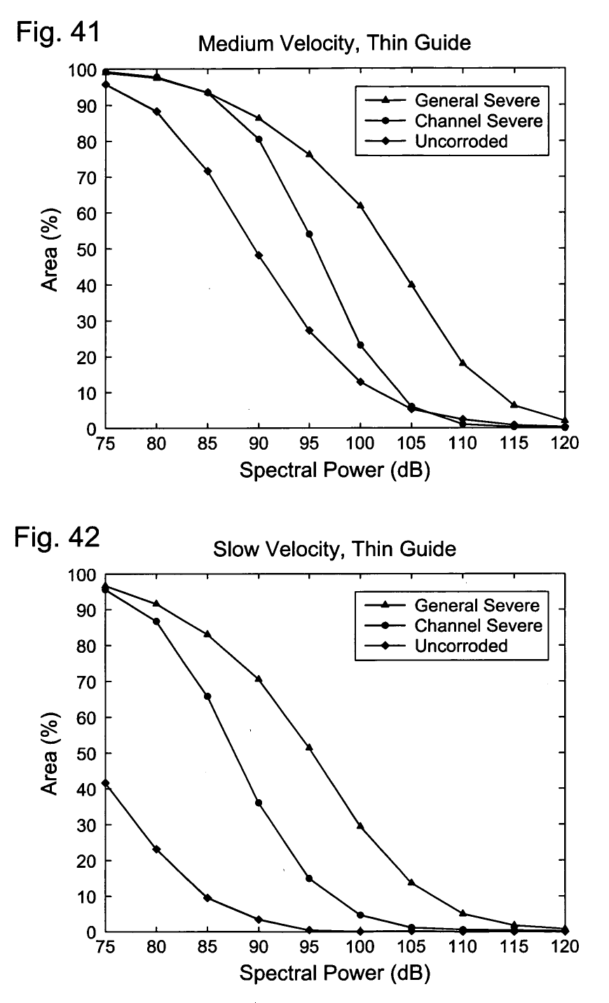

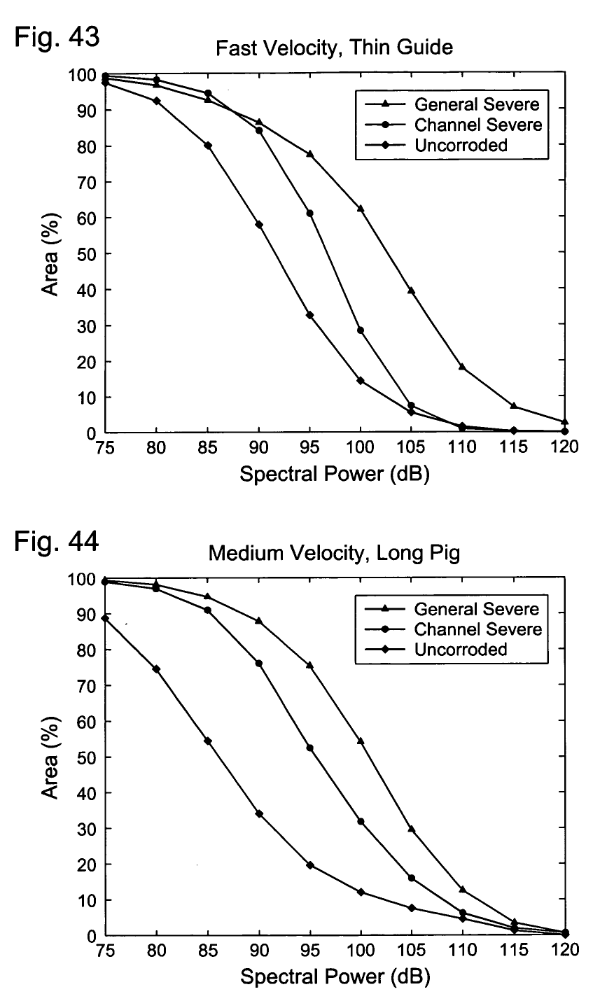

FIGS. 41, 42 and 43 show the response for the thin guide disk pig. The response is similar to the small diameter guide disk pig, with differences between the three spools. There is a big difference in response between the slow and medium velocities, but the response at the fast velocity is quite similar to the medium.

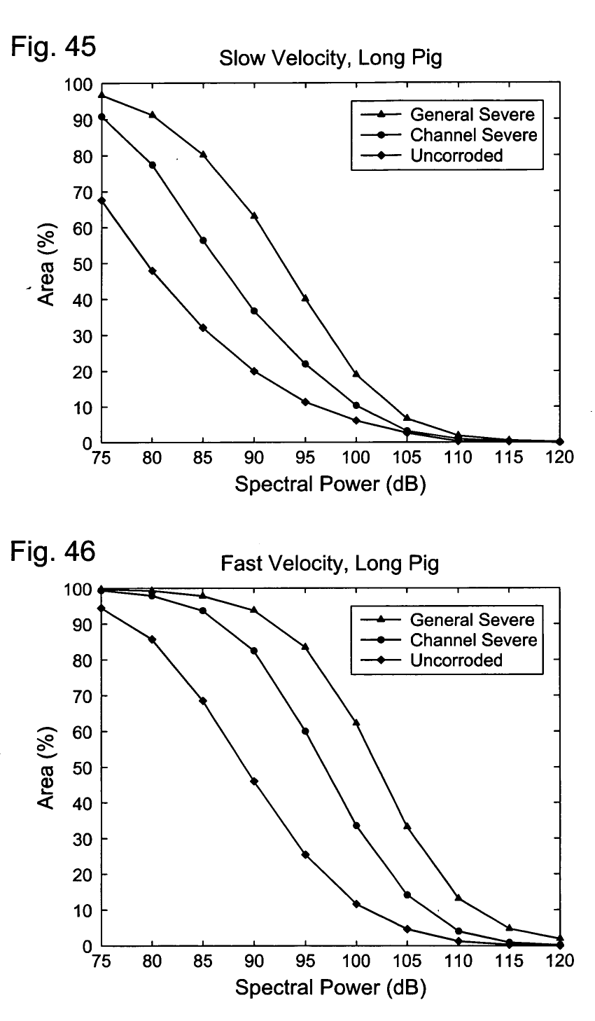

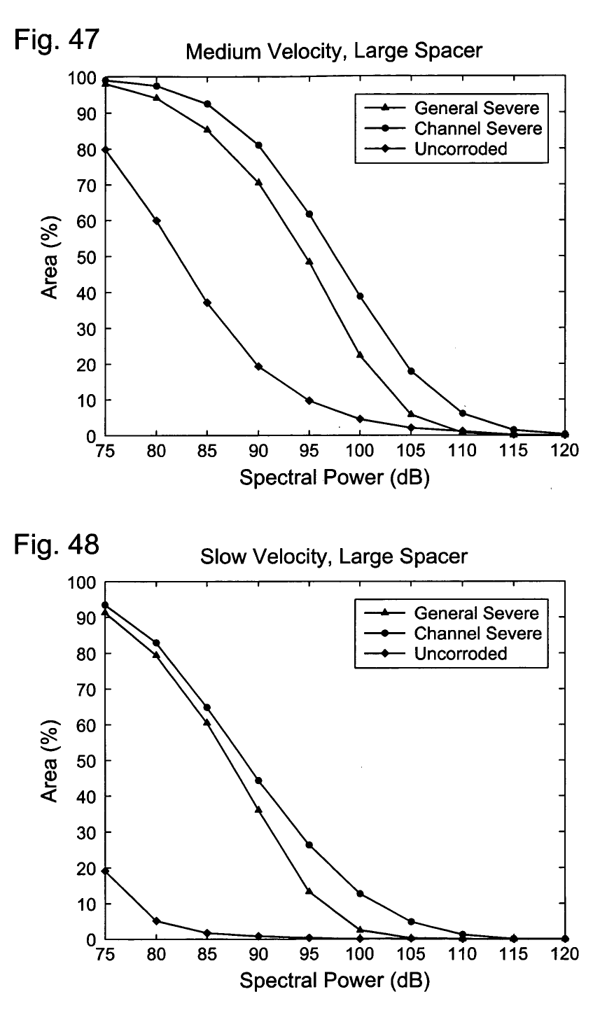

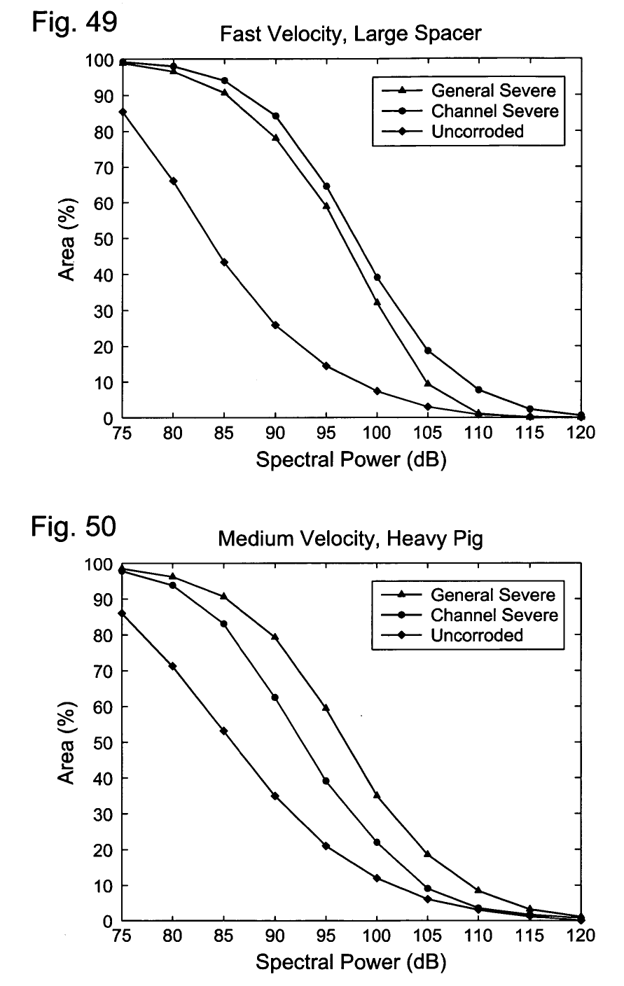

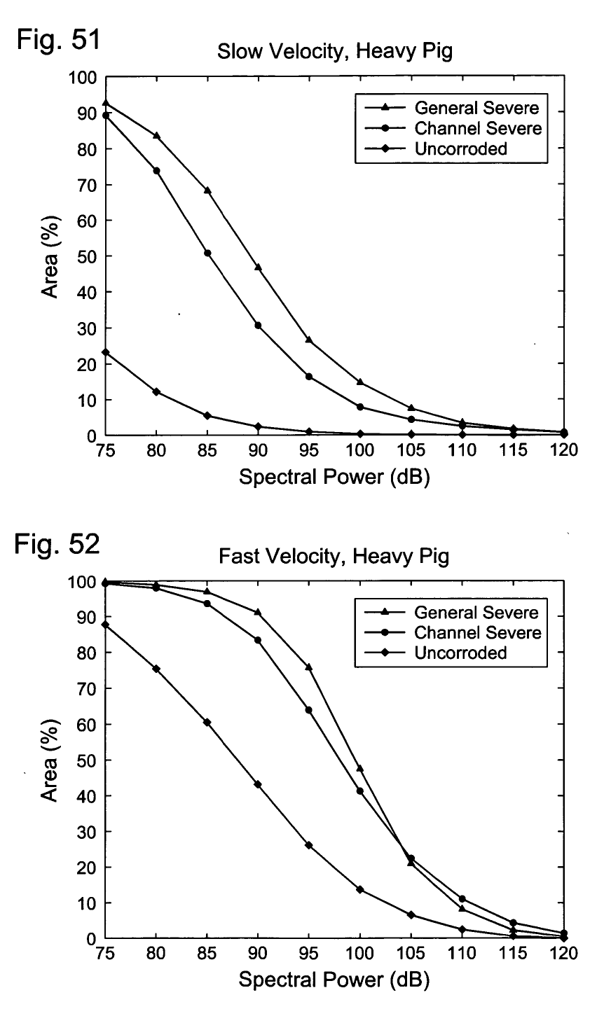

FIGS. 44, 45 and 46 show the responses for the long-bodied pig in three of the test spools. This pig has a relatively high response at the slowest velocity, but is similar to the standard pig at the other velocities. FIGS. 47, 48 and 49 show the responses for the large spacer pig. The pig has a relatively low response in both the un-corroded and severe general corrosion spool, and a relatively high response in the severe channel spool. FIGS. 50, 51 and 52 show the response for the heavy pig. These responses show a low level of response at the slowest velocity, but are relatively normal at higher velocities.

### CONCLUSIONS

The un-corroded spool has a markedly different response from each of the others. For most of the pig configurations, the severe general corrosion spool and the other corroded spools are distinguishable. In one aspect, distinguishing between the slight general corrosion spool and the channel corrosion spools is made with reference to the pig differential pressure data. While pig configuration affects the vibration response of the pig, additional vibration being caused by the increased roughness associated with corrosion is present for all pigs. This effect is particularly marked between 75 and 300 Hz. In most of the tests the vibration responses of the pigs are very similar for each repetition at a given velocity. Where there are exceptions, however (particularly for the un-corroded test-spool), they are in a small number of test loops where significant patterns of low frequency vibration exist that are unlike the normal signals. It is believed that the cause of this characteristic is the behavior of the pig, since the anomalous signal is not limited to the test spool. In one aspect, pig speed has a significant effect on the signal. Accordingly, it may be desirable to control speed during inspection of a line. Alternatively, the effects of speed may be calibrated, and the restriction may be relaxed to simply keeping the pig speed constant during the pig run.

In another aspect, variations in pig configuration are relevant in determining the details of the pig's vibration response. The general response for each configuration remains approximately the same in terms of the frequencies at which the vibration occurs, but the level of response varies significantly. In one aspect, it is believed that the degree of difference between the response in the corroded and un-corroded spools depends on pig configuration. In particular, a small disk oversize appears to give more variation in response than a large disk oversize, and small diameter guide disks give rise to increased sensitivity to velocity. Persons skilled in the art will appreciate that other factors will have effects on the frequency response of a pig. Such factors include, for example, disk wear, fluid properties, line size, pipeline burial, etc.

Example—Generation of a Spectrogram

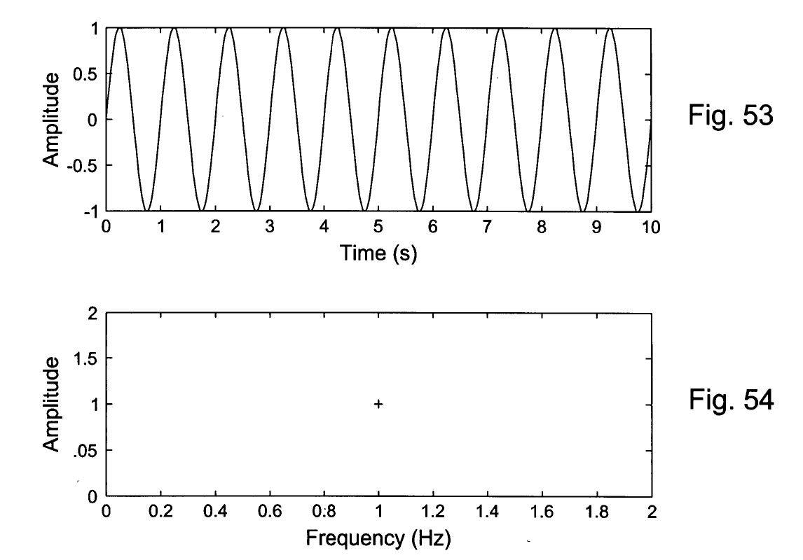

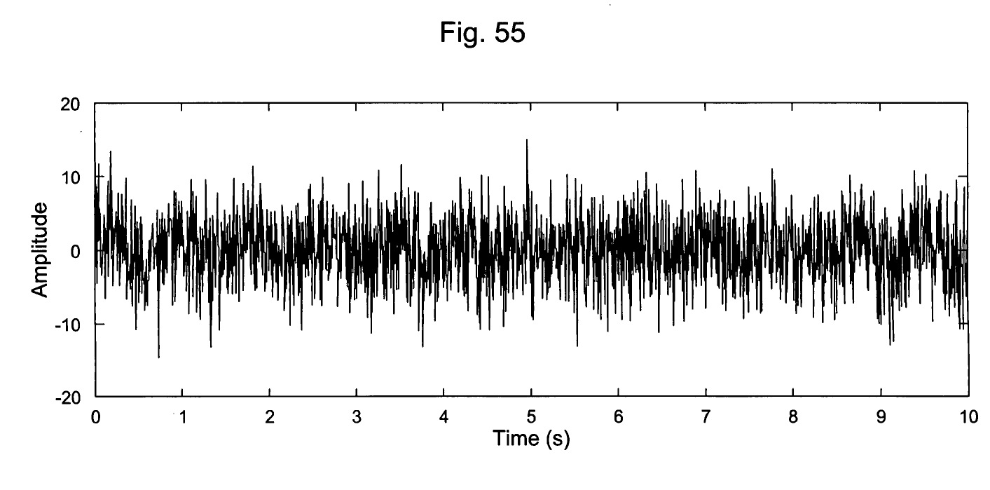

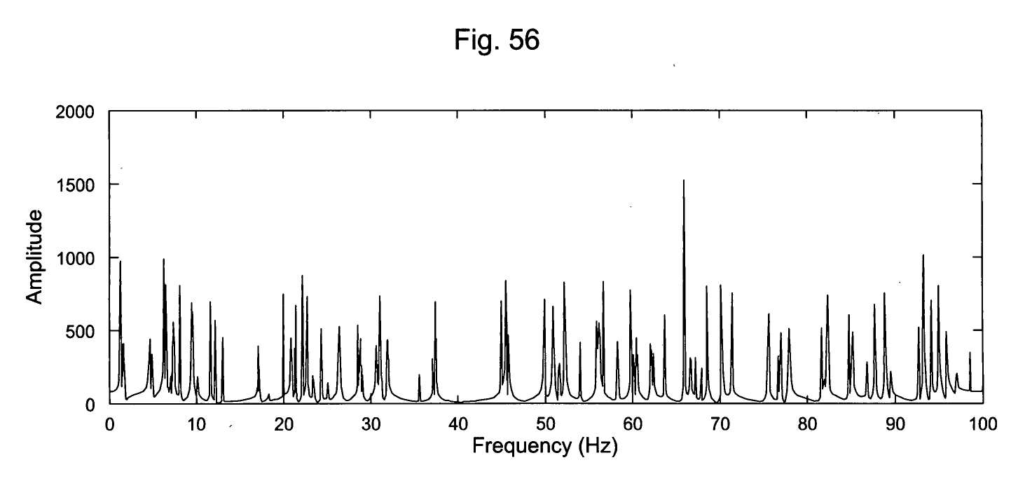

By way of illustration only, a description of generating a spectrogram is provided. This illustration is not limiting of the invention, as alternatives are possible and will be recognized by persons skilled in the art. The onboard system of the pig was configured to collect data at two different frequencies. The pressure, temperature and positioning data is recorded at a frequency of approximately 24 Hz, i.e. one reading is recorded from each instrument every 1/24th of a second. The vibration data is sampled at a much higher frequency, approximately 31 KHz. Some processing was performed on the time series of data to make the data more useful for analysis purposes. Specifically, to extract additional information from the time series data, a Fourier Transform was performed transform the data from a time series to a frequency spectrum. For purposes of illustration, consider the following. A simple sinusoidal wave from can be accurately represented at all times by two numbers—the frequency of the sine wave, and the amplitude of the waveform. The value at time t is then: F(t)=A sin(ωt). Graphically this may be seen in FIGS. 53 and 54. Both plots contain the same information. More generally, any time series can be decomposed into a set of sine waves of various amplitudes, frequencies and phases. The time series data can then be transformed into a frequency spectrum. The phase lag between components (i.e., the fact that all of the sine waves do not start from zero at the same instant) is expressed as a complex amplitude. For this reason, it is usual to quote the absolute value of the coefficients as the spectral strength. This representation is based on integral calculus, and strictly speaking applies only for continuous variables, i.e. ones with values defined at all times. In the field of data acquisition and signal processing this is not the case. The value of the signal is known at only discrete intervals, and it is therefore possible only to calculate the amplitudes of a discrete number of frequency components. Accordingly, instead of performing an integration to calculate the (continuous) frequency components at all frequencies, a summation determines the amplitudes of a number of discrete frequency components up to a limit determined by the sampling frequency. To illustrate, consider that in order to see that a signal is oscillating at a given frequency, one must capture at least two values from every cycle. From this it follows that the maximum frequency about which information can be captured form a sampled signal is half of the sampling frequency. Another effect of this is that the number of frequency divisions or ‘bins’ is half the number of time-series values used to calculate the frequency spectrum. As an example, FIGS. 55 and 56 show a signal made up of a 100 random frequency components between 0 and 100 Hz. Each component consists of a sine wave at the chosen frequency with random amplitude between zero and one. The signal itself is made up of one value every 0.005 seconds, or a sampling frequency of 200 Hz. The second trace shows the Discrete Fourier Transform of the full 10 seconds time-series. The individual frequencies that went to make up the signal are clearly visible.

In the current case, the pig is configured to capture data at approximately 31 KHz so that the theoretical maximum frequency about which useful information can be captured is 15.5 KHz. In practice this is restricted slightly further, by filtering out information above about 12 Khz in order to avoid so-called aliasing effects, where undersampling causes peaks at high frequencies to be shifted down the spectrum.

The data from the loop trials was prepared by taking 8192 samples (approximately 0.25 seconds, or 10 cm of data at the slowest test speed) and applying a cosine (Hanning) windowing function to give more weight to samples near the center of the series. A Fast Fourier Transform is then applied and a set of frequency components calculated. The window into the data was then moved on by 1024 samples (providing an overlap of 7168 samples or approximately 0.23 seconds), and the process repeated. This builds up a (3-D) representation of the signal known as a spectrogram. This information was then plotted out as a series of false color images, where the blue represented a low intensity, ranging up to red for high intensity. The signal level was plotted as 20×log 10(|amplitude|) in order to cover the large range of values. This puts the spectral power on a decibel scale.

While the foregoing is directed to embodiments of the present invention, other and further embodiments of the invention may be devised without departing from the basic scope thereof, and the scope thereof is determined by the claims that follow.

What is claimed is:

1. A method of deriving data representative of a condition of a pipeline comprising:
passing a pipeline pig along a pipeline;
generating data representative of an acoustical characteristic of the pipeline pig made as the pipeline pig moves through the pipeline pig; and
analyzing the data to determine a condition of the pipeline.

2. The method of claim 1, wherein the acoustical characteristic is a vibration frequency.

3. The method of claim 1, wherein the acoustical characteristic is a vibration signal amplitude.

4. The method of claim 1, further comprising, selecting a pig guide diameter, a seal diameter and a seal thickness to generate vibration frequency data characteristic of an internal condition of the pipeline.

5. The method of claim 1, further comprising, controlling a speed of the pipeline pig to within a suitable range to generate vibration frequency data characteristic of the internal condition of the pipeline.

6. The method of claim 1, further comprising, collecting data for use in determining a speed of travel of the pipeline pig along the pipeline.

7. The method of claim 1, further comprising, collecting data for use in determining a position of the pipeline pig along the pipeline.

8. The method of claim 1, wherein analyzing the data to determine a condition of the pipeline comprises filtering the data.

9. The method of claim 1, wherein analyzing the data to determine a condition of the pipeline comprises correlating data collected from a first sensor upon encountering a physical condition in the pipeline and data collected from a second sensor upon encountering the same physical condition in the pipeline.

10. The method of claim 1, wherein analyzing the data to determine a condition of the pipeline comprises correlating two or more of frequency data, data representative of the pig position along the pipeline and a speed of travel of the pig along the pipeline.

11. The method of claim 1, wherein analyzing comprises processing the data to remove frequency responses resulting from the pig passing known structures in the pipeline.

12. The method of claim 11, wherein the know structures include joints and bends.

13. The method of claim 1, wherein analyzing comprises identifying one or more known patterns.

14. The method of claim 11, wherein identifying one or more known patterns comprises comparing the data to reference data to identify a signature represented by the reference data, wherein the signature represents a known condition.

15. A method of deriving data representative of a condition of a pipeline comprising:
passing a pipeline pig along a pipeline;
sensing a frequency response generated by the pipeline pig as it moves along the pipeline;
generating data representative of the frequency response; and
analyzing the data to give data representative of the condition of the pipeline.

16. The method of claim 15, wherein analyzing the data comprises analyzing a frequency range between about 75 Hz and 300 Hz.

17. A computer readable medium containing a program which, when executed, performs an operation, comprising:
receiving a sensed frequency response generated as the pig moves along a pipeline by interaction between a physical structure of the pipeline pig and at least one of a structure of the pipeline and debris formed on the pipeline; and
generating data representative of the frequency response.

18. The computer readable medium of claim 17, wherein the operation further comprises analyzing the data to determine give data representative of the condition of the pipeline.

19. The computer readable medium of claim 17, wherein the operation further comprises storing the data for subsequent retrieval after removal of the pipeline pig from the pipeline.

20. An onboard pipeline pig system, comprising:
one or more vibration sensors configured to collect a sensed frequency response generated as a pig moves along a pipeline by interaction between a physical structure of the pipeline pig and at least one of a structure of the pipeline and debris formed on the pipeline; and
a processor connected to receive information representative of the sensed frequency response.

21. The system of claim 20, wherein the processor is configured to process the information representative of the sensed frequency response and determine a physical condition of the pipeline.

22. The system of claim 20, wherein the processor is configured to process the information representative of the sensed frequency response and determine a presence of corrosion in the pipeline.

23. The system of claim 20, wherein the processor is configured to process the information representative of the sensed frequency response in a range between about 75 Hz and 300 HZ.

24. A pipeline pig, comprising:
a casing;
an onboard pipeline pig system disposed at least partially within the casing and comprising:
one or more vibration sensors configured to collect a sensed frequency response generated as the pig moves along a pipeline by interaction between a physical structure of the pipeline pig and at least one of a structure of the pipeline and debris formed on the pipeline; and
a processor connected to receive information representative of the sensed frequency response.

25. The pipeline pig of claim 24, wherein the processor is configured to process the information representative of the sensed frequency response and determine a physical condition of the pipeline.

26. The pipeline pig of claim 24, wherein the processor is configured to process the information representative of the sensed frequency response and determine a presence of corrosion in the pipeline.

27. The pipeline pig of claim 24, wherein the processor is configured to process the information representative of the sensed frequency response in a range between about 75 Hz and 300 HZ.

28. The pipeline pig of claim 24, wherein the one or more vibration sensors comprise a first vibration sensor disposed at a first location on the pig and a second vibration sensor disposed at a second location on the pig.

29. The pipeline pig of claim 24, wherein the processor is configured to correlate data collected by the first and second sensors for a same event.

30. The pipeline pig of claim 24, wherein the processor is configured to correlate data collected by the first vibration sensor upon encountering a physical condition in the pipeline and data collected from the second vibration sensor upon encountering the same physical condition in the pipeline at a later time.
